(19) United States
(12) Patent Application Publication
(10) Pub. No.: US 2021/0191933 A1
(43) Pub. Date: Jun. 24, 2021

(54) DATA ANALYSIS DEVICE AND DATA ANALYSIS METHOD

(71) Applicant: HITACHI, LTD., Tokyo (JP)

(72) Inventors: Tadahisa KATO, Tokyo (JP); Yasunari TAKAI, Tokyo (JP); Yuichiro NAKAGAWA, Tokyo (JP); Ryota MIBE, Tokyo (JP); Toshiyuki UKAI, Tokyo (JP); Yasuharu NAMBA, Tokyo (JP)

(21) Appl. No.: 17/012,128

(22) Filed: Sep. 4, 2020

(30) Foreign Application Priority Data
Dec. 18, 2019 (JP) 2019-228493

(51) Int. Cl. G06F 16/2458; G06Q 10/06

(52) U.S. Cl. CPC G06F 16/2465; G06Q 10/06393

(57) ABSTRACT

A data analysis device 100 includes a storage device 101 configured to store pieces of knowledge used for data analysis, and a computing device 104 configured to perform a process of extracting variables defining the pieces of knowledge from the pieces of knowledge, a process of specifying values corresponding to the variables for data to be analyzed, and a process of performing, based on the values corresponding to the variables and a predetermined evaluation index, an analysis process for a relation between the variables and the evaluation index to specify information related to a combination of the variables for improving the evaluation index as a suggestion for improvement of the evaluation index.

### CROSS-REFERENCE TO RELATED APPLICATION

This application claims priority pursuant to 35 U.S.C. § 119 from Japanese Patent Application No. 2019-228493, filed on Dec. 18, 2019, the entire disclosure of which is incorporated herein by reference.

### BACKGROUND OF THE INVENTION

### 1. Field of the Invention

The present invention relates to a data analysis device and a data analysis method.

### 2. Description of the Related Art

There is known a method of performing data analysis on business data to identify factors that have a high correlation with business Key Performance Indicators (KPIs), thereby obtaining suggestions for business improvement. In such data analysis, there are cases in which the effectiveness of the obtained suggestions varies greatly depending on what variables are used for the data analysis.

For example, now consider a case in which the shortening of the picking process time, which is a business KPI, is to be accessed in picking work in a warehouse in a logistics industry.

For analysis data that includes only limited variables such as product names placed in the warehouse, results of performing data analysis on that data show suggestions of, for example, “Picking process time will be shortened if goods G1 is placed on shelf S1 in the warehouse”, “Picking process time will be shortened if goods G2 is placed on shelf S2 in the warehouse”, and “Picking process time will be shortened if goods G3 is placed on shelf S3 in the warehouse”.

In that case, there is a possibility that measures will be adopted such as “Place goods G1 on shelf S1 in the warehouse”, “Place goods G2 on shelf S2 in the warehouse”, and “Place goods G3 on shelf S3 in the warehouse”.

On the other hand, if the analysis data includes additional variables such as product sales and distances between the entrance and the shelves in the warehouse, there is a possibility that a suggestion that makes sense to humans and is highly reusable between cases will be obtained, such as “Place the best selling goods on the front side of the warehouse”.

Therefore, it is important to predict variables that are likely to be highly correlated with the business KPIs using business knowledge, and to include such variables in analysis data as much as possible. As a conventional technique related to such a concept, for example, a data analysis device has been proposed that includes a reception unit configured to receive one or more constraints that formally describe information used for making a decision when a data analyst selects attributes to be used for analysis from among explanatory variables, one or more explanatory variables, and one or more objective variables; and an analysis unit configured to perform data analysis on attributes included in a selection pattern of one or more attributes that satisfy the constraints obtained from the explanatory variables. For example, refer to Japanese Patent Application Laid-Open Publication No. 2018-088087.

However, the business knowledge as described above does not always help make an effective suggestion. Business knowledge that was useful in one case may not be useful in another case.

For example, now consider a case in which a logistics company having a plurality of bases responds to the needs for shortening the picking process time (business KPI) for each base in warehouse picking work. In this situation, suppose that data analysis is performed on analysis data including variables related to goods weight and the arrangement of shelves in accordance with the business knowledge that the goods weight and the arrangement of shelves are likely to affect the picking process time.

However, for example, if there are instructions such as “At base A, load every good on the cart by hand” and “At base B, a forklift is available to load goods on the cart”, a suggestion for the business data in base A may be obtained corresponding to the business knowledge, such as “Picking process time will be shortened if goods having a weight of 5 kg or more is placed in the middle of the shelves” while such a suggestion may not be obtained for the business data in base B. In other words, the business knowledge that “goods weight and the arrangement of shelves are likely to affect the picking process time” is not suitable for base B.

The situation as described above leads to the result that data analysis for business improvement is not performed accurately, and it is difficult to expect the effectiveness of the suggestions and measures based on the result of such data analysis.

Therefore, an objective of the present invention is to provide a technique capable of determining useful business knowledge depending on cases to provide an effective suggestion for business improvement with high accuracy.

### SUMMARY

In order to solve the above-mentioned problems, a data analysis device of the present invention includes a storage device configured to store pieces of knowledge used for data analysis; and a computing device configured to perform a process of extracting variables defining the pieces of knowledge from the pieces of knowledge, a process of specifying values corresponding to the variables for data to be analyzed, and a process of performing, based on the values corresponding to the variables and a predetermined evaluation index, an analysis process for a relation between the variables and the evaluation index to specify information related to a combination of the variables for improving the evaluation index as a suggestion for improvement of the evaluation index.

Further, a data analysis method of the present invention is performed by an information processing device, and includes storing, in a storage device, pieces of knowledge used for data analysis; and performing a process of extracting variables defining the pieces of knowledge from the pieces of knowledge, a process of specifying values corresponding to the variables for data to be analyzed, and a process of performing, based on the values corresponding to the variables and a predetermined evaluation index, an analysis process for a relation between the variables and the evaluation index to specify information related to a combination of the variables for improving the evaluation index as a suggestion for improvement of the evaluation index.

### BRIEF DESCRIPTION OF DRAWINGS

FIG. 1 is a network configuration diagram including a data analysis device according to an embodiment;

FIG. 2 illustrates a hardware configuration example of the data analysis device according to the embodiment;

FIG. 3 illustrates a functional configuration example of the data analysis device according to the embodiment;

FIG. 4 illustrates a process example of a knowledge acquisition unit according to the embodiment;

FIG. 5 illustrates an example of knowledge (at the time of user input) according to the embodiment;

FIG. 6 illustrates an example of knowledge (at the time of storage) according to the embodiment;

FIG. 7 illustrates a process example of a knowledge selection unit according to the embodiment;

FIG. 8 illustrates an example of a knowledge list according to the embodiment;

FIG. 9 illustrates an example of a knowledge list according to the embodiment;

FIG. 10 illustrates an example of a knowledge selection criterion according to the embodiment;

FIG. 11 illustrates an example of a selection knowledge list according to the embodiment;

FIG. 12 illustrates a process example of the knowledge selection unit according to the embodiment;

FIG. 13 illustrates an example of a necessary variable list according to the embodiment;

FIG. 14 illustrates a process example of the knowledge selection unit according to the embodiment;

FIG. 15 illustrates an example of knowledge (constraint condition) according to the embodiment;

FIG. 16 illustrates a process example of pre-processing analysis according to the embodiment;

FIG. 17 illustrates an example of raw data according to the embodiment;

FIG. 18 illustrates an example of analysis data according to the embodiment;

FIG. 19 illustrates a process example of a learning unit according to the embodiment;

FIG. 20 illustrates an example of a suggestion list according to the embodiment;

FIG. 21 illustrates an example of a suggestion according to the embodiment;

FIG. 22 illustrates a process example of a planning unit according to the embodiment;

FIG. 23 illustrates an example of a measure list according to the embodiment;

FIG. 24 illustrates an example of measures according to the embodiment;

FIG. 25 illustrates a process example of the planning unit according to the embodiment;

FIG. 26 illustrates an example of measures according to the embodiment;

FIG. 27 illustrates a process example of a measure implementation unit according to the embodiment;

FIG. 28 illustrates an example of an implementation result according to the embodiment;

FIG. 29 illustrates a process example of an evaluation unit according to the embodiment;

FIG. 30 illustrates an example of an implementation result for each piece of knowledge according to the embodiment;

FIG. 31 illustrates a process example of the evaluation unit according to the embodiment;

FIG. 32 illustrates an example of knowledge (after score is given) according to the embodiment;

FIG. 33 illustrates a process example of the evaluation unit according to the embodiment;

FIG. 34 illustrates a functional configuration example of a data analysis device according to the embodiment;

FIG. 35 illustrates a process example of a score prediction unit according to the embodiment;

FIG. 36 illustrates an example of knowledge (with the score prediction unit) according to the embodiment;

FIG. 37 illustrates an example of a case for which a score is to be predicted according to the embodiment;

FIG. 38 illustrates an example of a knowledge co-occurrence table according to the embodiment;

FIG. 39 illustrates an example of a knowledge co-occurrence rule according to the embodiment;

FIG. 40 illustrates an example of knowledge (with the score prediction unit) according to the embodiment;

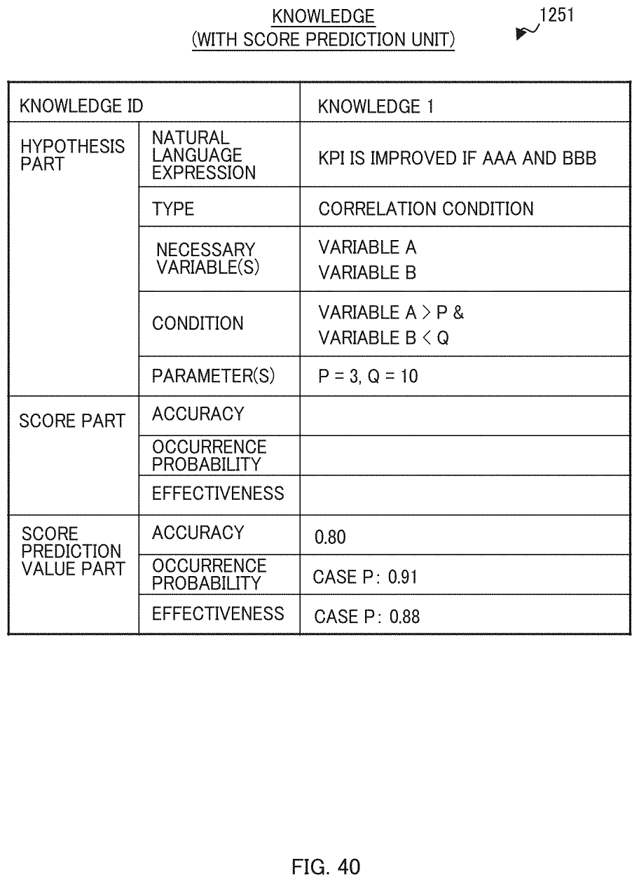

FIG. 41 illustrates a process example of a knowledge selection unit according to the embodiment; and

FIG. 42 illustrates an output example according to the embodiment.

### DESCRIPTION OF EMBODIMENTS

<Network Configuration>

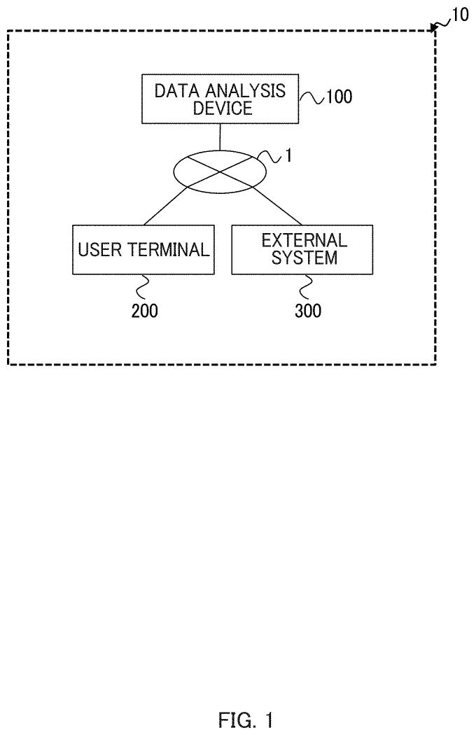

Embodiments of the present invention will be described below in detail with reference to the drawings. FIG. 1 is a network configuration diagram including a data analysis device 100 according to an embodiment. The data analysis device 100 illustrated in FIG. 1 is a computer device capable of determining useful business knowledge depending on cases to provide an effective suggestion for business improvement with high accuracy.

This data analysis device 100 may be, for example, a server device operated in a department responsible for business improvement for a business operator, or a consulting company that proposes business improvement to that business operator.

Further, the data analysis device 100 is communicatively connected to other devices such as a user terminal 200 and an external system 300 via a suitable network 1 such as the Internet or a LAN (Local Area Network). A data analysis system 10 includes the data analysis device 100, the user terminal 200, and the external system 300.

Of these devices, the user terminal 200 is an information processing device that receives, from a user (the person in charge in the above-mentioned business operator, etc.), a specification for a case and knowledge to be processed to the data analysis device 100 described above, and also acquires and displays a result of processing in the data analysis device 100.

Further, the external system 300 is a business system that manages, based on a result of processing in the data analysis device 100 (e.g., suggestion for improvement of evaluation index), information related to measures implemented by the above-mentioned business operator and its result (KPI value which is an evaluation index).

This external system 300 distributes to the data analysis device 100 the information related to the measures implemented by the above-mentioned business operator and its results, in response to a request or when a predetermined time elapses.

<Hardware Configuration>

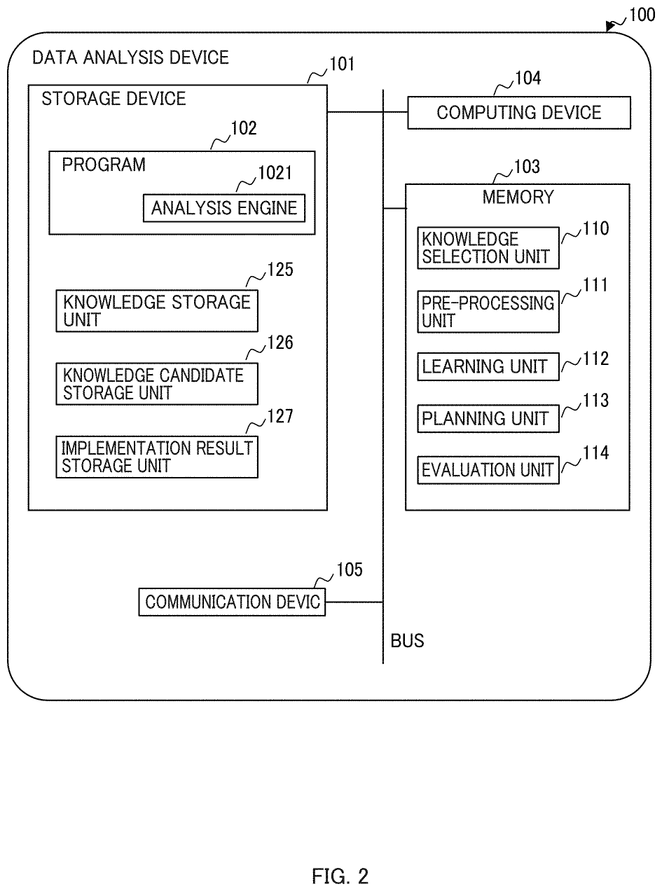

Further, a hardware configuration of the data analysis device 100 according to the embodiment is as illustrated in FIG. 2. Specifically, the data analysis device 100 includes a storage device 101, a memory 103, a computing device 104, and a communication device 105.

Of these devices, the storage device 101 includes a suitable nonvolatile storage element such as an SSD (Solid State Drive) or a hard disk drive.

Further, the memory 103 includes a volatile storage element such as a RAM.

Further, the computing device 104 is a CPU that loads a program 102 stored in the storage device 101 into the memory 103 to execute it, thereby implementing necessary functions 110 to 114 so that the data analysis device 100 is integrally controlled and various determinations, computation, and control processing are performed.

Note that the functions 110 to 114 described above are illustrated in FIG. 2 such that a knowledge selection unit 110, a pre-processing unit 111, a learning unit 112, a planning unit 113, and an evaluation unit 114, respectively, are implemented in the memory 103. Details of each of these functional units will be described below.

Further, the program 102 herein includes a suitable analysis engine 1021 such as a correlation analysis engine. This analysis engine 1021 may use an existing analysis application.

Further, the communication device 105 is a network interface card that is connected to the network 1 to handle a communication process with other devices.

The data analysis device 100 may also include an input device and an output device as appropriate. The input device is a suitable device such as a keyboard, a mouse, or a microphone for receiving a key input or a voice input from the user. Further, the output device is a suitable device such as a display or a speaker for displaying processed data in the computing device 104.

Further, in the storage device 101, at least a knowledge storage unit 125, a knowledge candidate storage unit 126, and an implementation result storage unit 127 are stored in addition to the program 102 for implementing the functions required as the data analysis device 100 according to the present embodiment. Details of each of these storage units will be described below.

<Function Examples>

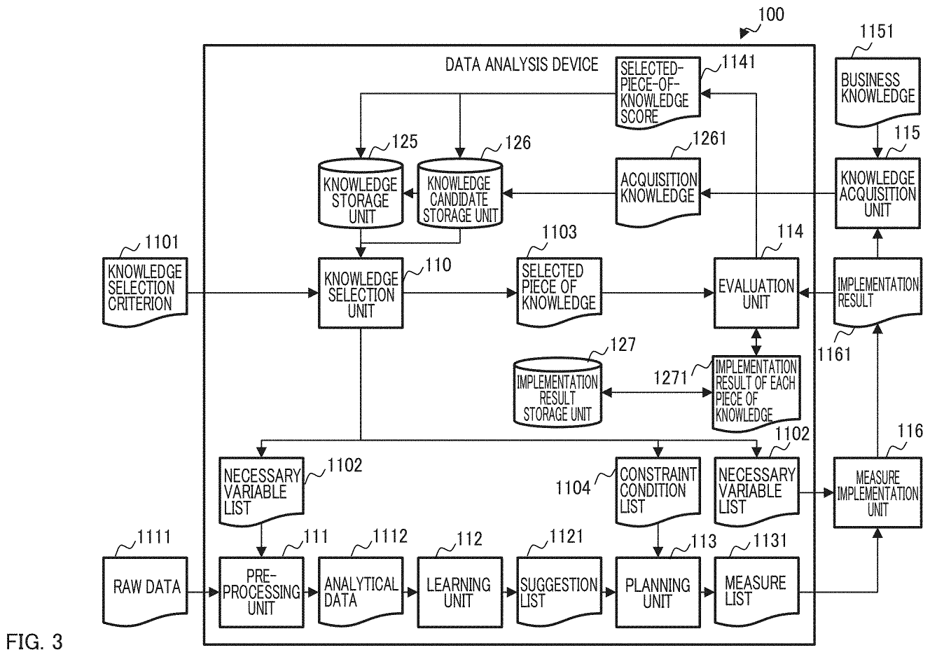

Next, the functions of the data analysis device 100 according to the present embodiment will be described. FIG. 3 illustrates a functional configuration example of the data analysis device 100 according to the present embodiment. The knowledge selection unit 110 of the data analysis device 100 selects, as a piece to be processed, a piece of knowledge that satisfies a knowledge selection criterion 1101 from among pieces of knowledge held in the knowledge storage unit 125 and the knowledge candidate storage unit 126, and selectively extracts variable(s) that define the piece of knowledge from the selected piece of knowledge to generate a necessary variable list 1102 and a constraint condition list 1104.

Note that the knowledge selection criterion 1101 described above may define the lower limit values of scores of items such as accuracy, occurrence probability, and effectiveness described below. Accordingly, the knowledge selection unit 110 may output information about a piece of knowledge selected based on such a score to a predetermined device such as the user terminal 200.

The necessary variable list 1102 and the constraint condition list 1104 include variables whose usefulness as knowledge is secured by the knowledge selection criterion 1101 described above. Of these lists, the constraint condition list 1104 includes variables defined as a prohibited matter.

Further, the knowledge selection unit 110 also passes the necessary variable list 1102 selected as described above to the pre-processing unit 111. Similarly, the knowledge selection unit 110 passes the constraint condition list 1104 to the planning unit 113. The knowledge selection unit 110 also passes the piece of knowledge selected as a piece to be processed, that is, a selected piece of knowledge 1103 to the evaluation unit 114.

On the other hand, the pre-processing unit 111 specifies values corresponding to the variables indicated by the necessary variable list 1102 described above with respect to raw data 1111 to be analyzed, and generates analysis data 1112. The pre-processing unit 111 passes the analysis data 1111 to the learning unit 112. The raw data 1111 is provided by the external system 300, for example.

The learning unit 112 causes the analysis engine 1021 to perform, based on the values corresponding to the respective variables described above indicated by the analysis data 1112 and a predetermined evaluation index, an analysis process for a relation between each variable and the evaluation index.

Note that examples of the above-mentioned evaluation index may include various parameters associated with business efficiency, such as picking process time at a logistics facility operated by a logistics business operator, and manufacturing efficiency and yield rate at a manufacturing facility operated by a manufacturer of products or parts and the like. Needless to say, the evaluation index is not limited to such business efficiency.

Further, the learning unit 112 obtains information related to a combination of the variables that improves the evaluation index as a result of the analysis process for the relation between each variable and the evaluation index described above, and specifies the information as a suggestion for improvement of the evaluation index, that is, a suggestion list 1121.

Further, the planning unit 113 generates, based on the suggestion list 1121 and the constraint condition list 1104 described above, a list of measures that achieve the condition for each variable indicated by the suggestion list 1121, that is, a measure list 1131, under the constraint condition indicated by the constraint condition list 1104, and provides the measure list 1131 to the measure implementation unit 116. This measure implementation unit 116 is a device that implements the measures indicated in the measure list 1131. However, the measure implementation unit 116 itself may acquire an implementation result of the measure in facility or personnel to which the measure is applied from the external system 300 or the like without implementing the measure.

The implementation result obtained by the above-mentioned measure implementation unit 116 implementing the measure is provided to the evaluation unit 114. The evaluation unit 114 obtains this implementation result, and performs, based on at least a record value of the above-described evaluation index indicated by the implementation result, scoring a piece of knowledge corresponding to the above-mentioned measure (suggestion for improvement of the evaluation index), that is, the selected piece of knowledge 1103. Note that the evaluation unit 114 may store the implementation result 1161 in the implementation result storage unit 127 so as to read and use it when performing the process as appropriate.

The scoring process in the evaluation unit 114 corresponds to, for example, a process of calculating a score for items such as accuracy, occurrence probability, and effectiveness.

Of these items, the accuracy is a ratio of the number of cases in which improvement of the corresponding evaluation index (e.g., picking process time) has been confirmed to the number of cases in which the improvement condition of the evaluation index (e.g., goods A with an attribute X being placed within W meters from a position Z in an area Y) that is defined by the corresponding measure has actually occurred. Note that the number of cases here refers to, for example, the number of business cases to which the measure is applied.

When the number of cases in which the improvement condition has actually occurred described above referred to as “the number of IF occurrence cases” and the number of cases in which the above improvement has been confirmed is referred to as “the number of KPI improved cases”, the accuracy is represented by an expression of (the number of KPI improved cases)/(the number of IF occurrence cases).

Further, the occurrence probability is a ratio of the number of cases in which the improvement condition of the evaluation index defined in the above-mentioned measure has actually occurred to the total number of business cases mentioned above, that is, the number of evaluation cases. This relation is represented by an expression of (the number of IF occurrence cases)/(the number of evaluation cases).

Further, the effectiveness is a ratio of the amount of improvement of the evaluation index to the number of cases in which the improvement condition of the evaluation index defined in the above-mentioned measure has actually occurred. When the amount of improvement of the evaluation index is referred to as the “ΣKPI change amount”, the effectiveness is represented by an expression of (the ΣKPI change amount)/(number of IF occurrence cases).

The evaluation unit 114 stores the value of each score obtained by the above-mentioned scoring as a selected-piece-of-knowledge score 1141 which serves as a score of the corresponding piece of knowledge in the knowledge acquisition unit 115 or the knowledge candidate storage unit 126, or an updated difference from an existing score.

Note that the knowledge acquisition unit 115 stores, as new acquisition knowledge 1261, the implementation result 1161 (i.e., a piece of knowledge made up of a combination of variables that improve the evaluation index, and various values obtained by implementing the corresponding measure) and the business knowledge 1151 described above in the knowledge candidate storage unit 126.

For example, when a score updated by the scoring performed by the evaluation unit 114 described above exceeds a predetermined criterion for a candidate knowledge stored in the knowledge candidate storage unit 126 described above, the knowledge selection unit 110 transfers the candidate for knowledge as a piece of knowledge to the knowledge storage unit 125.

Note that the evaluation unit 114 refers to information on each piece of knowledge acquired for each business case, which is stored by the knowledge storage unit 125 or the knowledge candidate storage unit 126, as appropriate so as to be able to perform, for example, score estimation on a piece(s) on which the above-mentioned scoring has not been performed, of pieces of knowledge about a target case specified by the user.

In this case, the evaluation unit 114 refers to a piece of knowledge which is of another case different from the target case and which has not been scored for the target case, in the knowledge storage unit 125 or the knowledge candidate storage unit 126, and extracts the score that has been obtained for the other case for the piece of knowledge.

Further, the evaluation unit 114 calculates, based on the score extracted here, for example, an average value or a median value of the scores as a score of the corresponding piece of knowledge for the target case, that is, performs score analogy.

Note that the evaluation unit 114 may perform a co-occurrence analysis on pieces of knowledge based on the information of pieces of knowledge obtained for respective cases in the knowledge storage unit 125 or the knowledge candidate storage unit 126 in the above-mentioned score analogy, specify a piece(s) of knowledge that can co-occur with the piece of knowledge for the target case described above, and perform the above-mentioned score analogy on a piece(s) that has/have not been scored, of the specified pieces of knowledge.

For example, suppose that knowledge 1, knowledge 2, and knowledge 3 for case A, knowledge 1, knowledge 2, knowledge 3, knowledge 4, and knowledge 5 for case B, knowledge 1, knowledge 2, knowledge 3, and knowledge 6 for case C have been obtained. When co-occurrence analysis is performed on these, it can be specified that knowledge 1 and knowledge 2 have co-occurrence, and knowledge 1 and knowledge 3 also have co-occurrence.

Further, if a piece of knowledge obtained in target case X is knowledge 1, it is specified that knowledge 2 and knowledge 3 may also be effective in case X in consideration of the results of the co-occurrence analysis described above. Accordingly, the evaluation unit 114 will perform the above-mentioned score analogy for knowledge 2 and knowledge 3 specified here.

The score analogy in the above case is to calculate an average or a median of the values of knowledge 2 in case A, case B, and case C for knowledge 2, and estimate the calculation result as the value of knowledge 2 for case X. The same applies to the score analogy for knowledge 3.

<Data Analysis Method: Flow in Knowledge Acquisition Unit>

An actual procedure of a data analysis method according to the present embodiment will be described below with reference to the drawings. Various operations corresponding to the data analysis method described below are implemented by the data analysis device 100 reading a program into a memory or the like and executing it. The program is composed of codes for performing various operations described below.

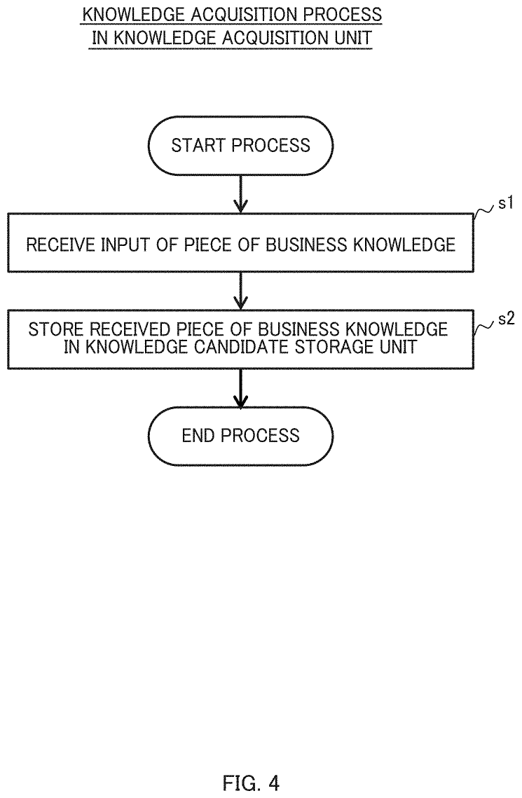

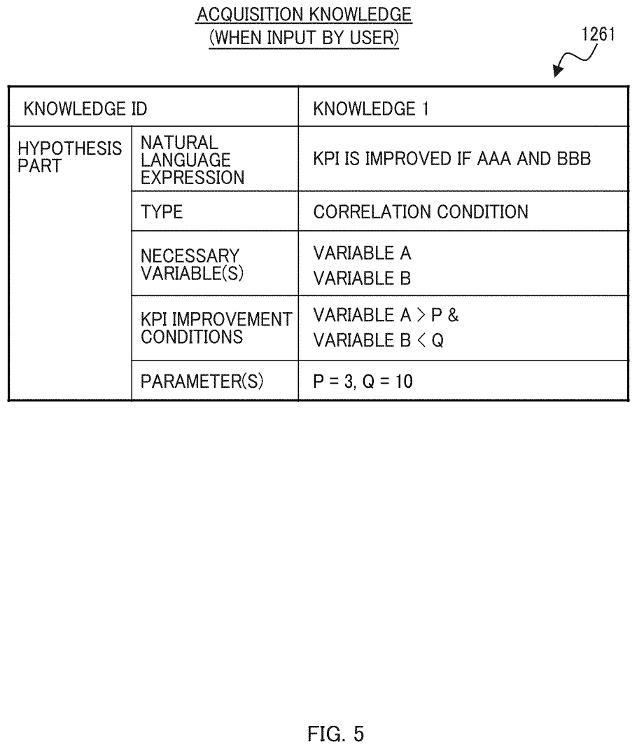

FIG. 4 illustrates an example of a flow of the data analysis method according to the present embodiment, specifically, a process performed in the knowledge acquisition unit 115. In this case, the knowledge acquisition unit 115 receives, for example, a piece of business knowledge (see acquisition knowledge 1261 in FIG. 5) input by a user in charge of business improvement via the user terminal 200 (s1).

The piece of business knowledge received here includes a record in which a hypothesis part is associated with a knowledge ID for uniquely identifying the piece of knowledge as a key. This hypothesis part defines the piece of knowledge with items, and includes values such as natural language expression, type, necessary variable(s), conditions, and parameter(s) of the piece of knowledge.

Of these items, the type may be of one of two types: correlation condition and constraint condition. When the variable(s) defined as the “necessary variable(s)” are those defined by the “KPI improvement conditions” and the “parameter(s)”, the correlation condition indicates knowledge about a condition that the variables are correlated with the improvement of the evaluation index (KPI). On the other hand, the constraint condition indicates knowledge about a forbidden condition that the variable(s) defined by the “necessary variable(s)” are not those defined by the “forbidden condition” and the “parameter(s)”.

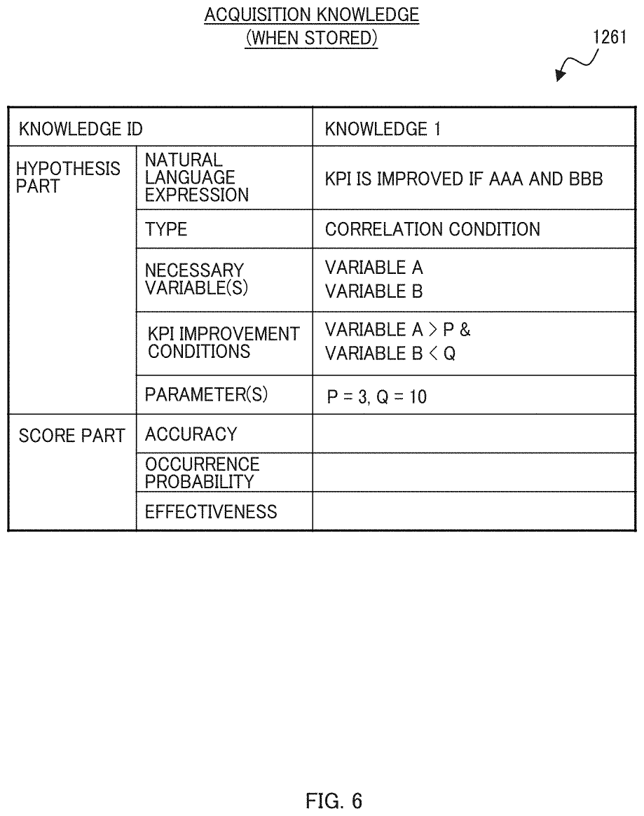

Further, the knowledge acquisition unit 115 stores the piece of business knowledge received in s1 in the knowledge candidate storage unit 126 (s2), and then the process ends. Each record of business knowledge (see FIG. 6) stored in the knowledge candidate storage unit 126 includes an item of score part in addition to the item (hypothesis part) of the acquisition knowledge 1261 of FIG. 5. However, since the scoring has not been performed at this time, the corresponding item is blank.

<Data Analysis Method: Flow Example 1 in Knowledge Selection Unit>

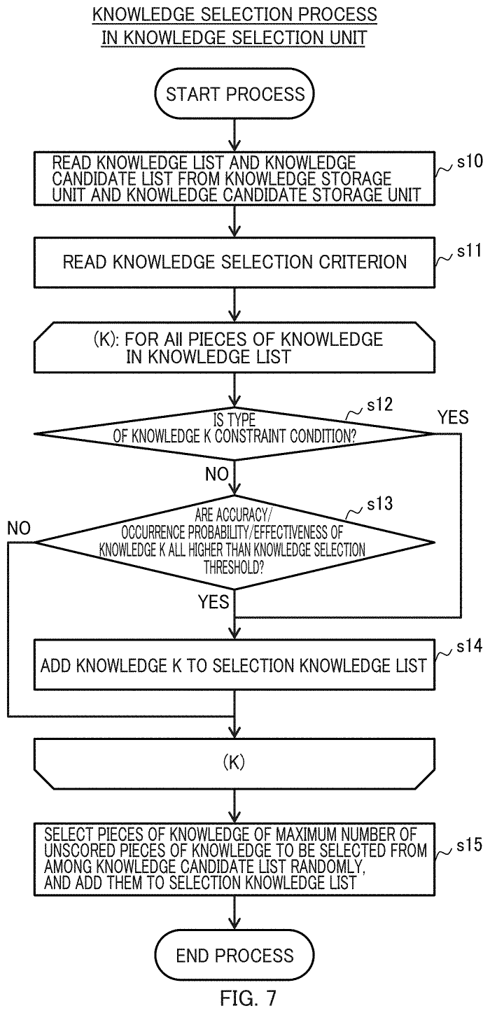

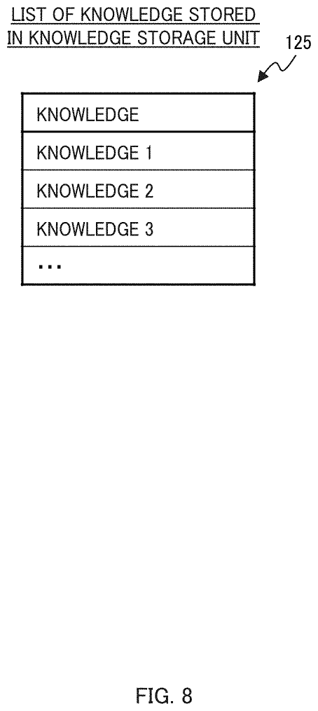

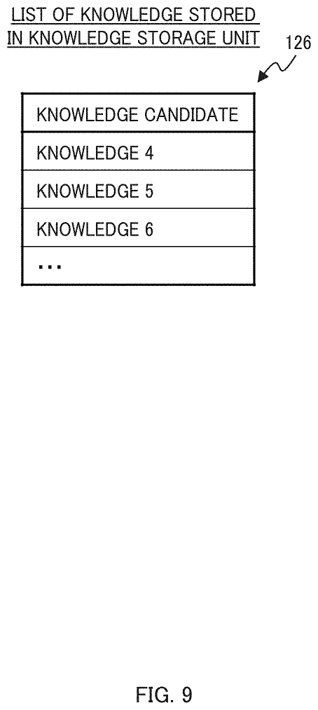

Next, a flow in the knowledge selection unit 110 will be described. FIG. 7 illustrates a flow example in the data analysis method according to the present embodiment, specifically, a knowledge selection process in the knowledge selection unit 110. In this case, the knowledge selection unit 110 acquires a knowledge list and a knowledge candidate list (see FIGS. 8 and 9) from the knowledge storage unit 125 and the knowledge candidate storage unit 126 (s10).

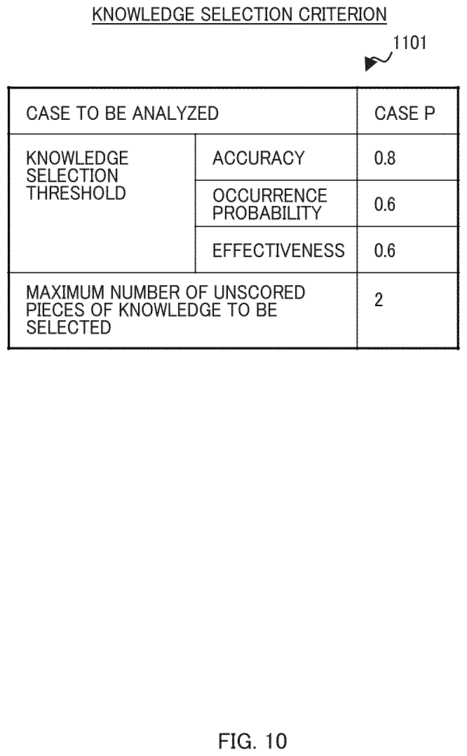

Further, the knowledge selection unit 110 reads the knowledge selection criterion 1101 (see FIG. 10) (s11), and performs the processes of s12 to s14 for each piece of knowledge in the knowledge list obtained in s10.

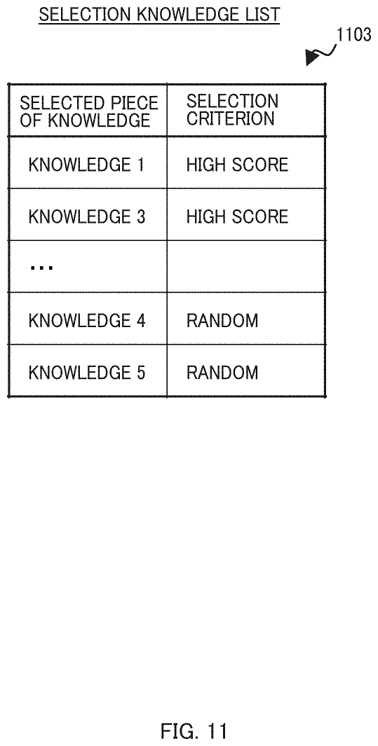

In s12 of these processes, the knowledge selection unit 110 determines whether the value in the “type” field is the “constraint condition” for the piece of knowledge to be processed. As a result of this determination, if the piece of knowledge corresponds to the “constraint condition” (s12: Yes), the knowledge selection unit 110 adds the piece of knowledge to a selection knowledge list 1103 (see FIG. 11) (s14).

On the other hand, as a result of the above determination, if the piece of knowledge does not correspond to the “constraint condition” (s12: No), the knowledge selection unit 110 determines whether the values of the items of accuracy, occurrence probability, and effectiveness in the score part for the piece of knowledge are all higher than the values defined by the knowledge selection criterion 1101 (s13).

As a result of this determination, if the values of the items of accuracy, occurrence probability, and effectiveness for the piece of knowledge are all higher than the values defined by the knowledge selection criterion 1101 (s13: Yes), the knowledge selection unit 110 adds the piece of knowledge to the selection knowledge list 1103. On the other hand, as a result of this determination, if any of the values of the items of accuracy, occurrence probability, and effectiveness for the piece of knowledge is not higher than the value defined by the knowledge selection criterion 1101 (s13: No), the knowledge selection unit 110 does not add the piece of knowledge to the selection knowledge list 1103, and the processing proceeds to the process for another piece of knowledge.

When the processes of s12 to s14 described above have been performed on all pieces of knowledge in the knowledge list, the knowledge selection unit 110 randomly selects, from among the knowledge candidate list, pieces of knowledge of the “maximum number of unscored pieces of knowledge to be selected” in the knowledge selection criterion 1101, adds the selected pieces of knowledge to the selection knowledge list 1103 (s15), and then the process ends.

Note that the selection knowledge list 1103 may include a selection criterion associated with the piece of knowledge selected in s12 to s14 described above. An example of FIG. 11 illustrates that knowledge 1 and knowledge 3 are selected because their accuracy, occurrence probability, and effectiveness have a “high score”, and knowledge 4 and knowledge 5 are randomly selected according to the “maximum number of unscored pieces of knowledge to be selected”.

<Data Analysis Method: Flow Example 2 in Knowledge Selection Unit>

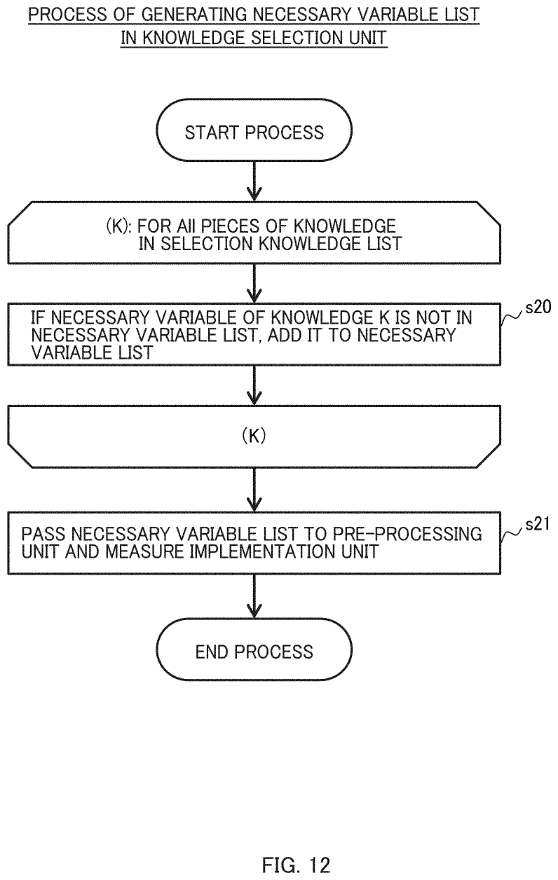

Next, a process of generating the necessary variable list 1102 in the knowledge selection unit 110 will be described. FIG. 12 illustrates a flow example in the data analysis method according to the present embodiment, specifically, the process of generating the necessary variable list in the knowledge selection unit 110.

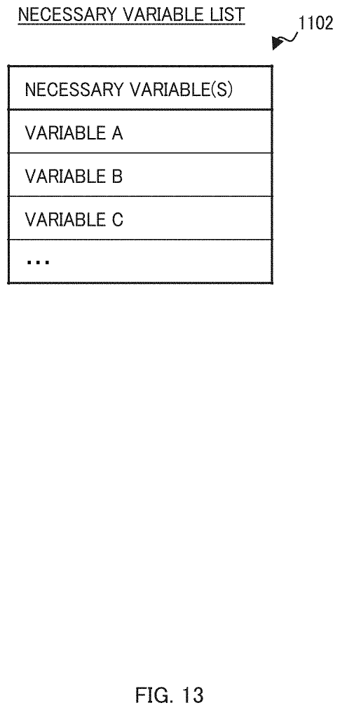

In this case, the knowledge selection unit 110 performs the following process of s20 on all the pieces of knowledge in the selection knowledge list 1103. Specifically, if “necessary variable(s)” for the piece of knowledge to be processed among the pieces of knowledge in the selection knowledge list 1103 are not stored in the necessary variable list 1102 (see FIG. 13), the knowledge selection unit 110 adds the necessary variable(s) to the necessary variable list 1102 (s20).

The knowledge selection unit 110 performs such a process for all the pieces of knowledge in the selection knowledge list 1103 to generate the necessary variable list 1102, and passes the necessary variable list 1102 to the pre-processing unit 111 and the measure implementation unit 116 (s21), and then the process ends.

<Data Analysis Method: Flow Example 3 in Knowledge Selection Unit>

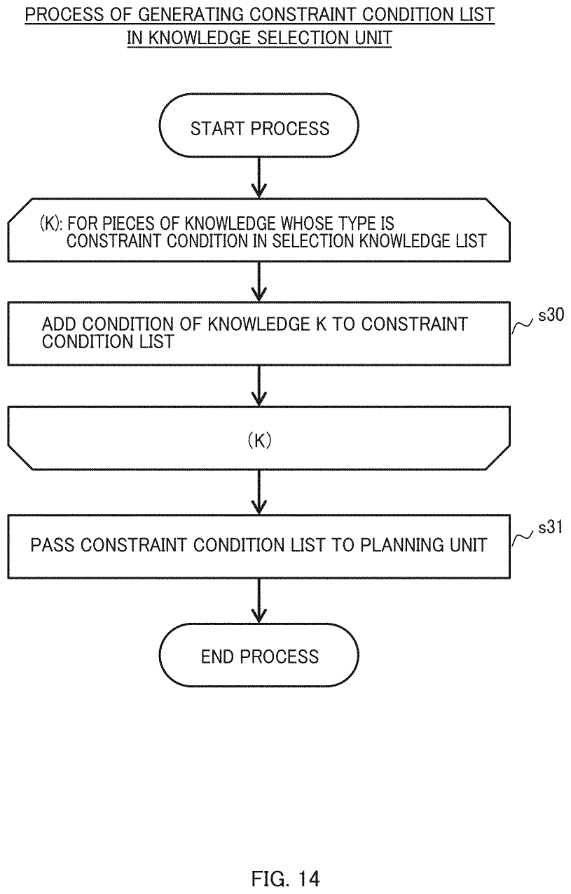

Next, a process of generating the constraint condition list 1104 in the knowledge selection unit 110 will be described. FIG. 14 illustrates a flow example in the data analysis method according to the present embodiment, specifically, the process of generating the constraint condition list 1104 in the knowledge selection unit 110.

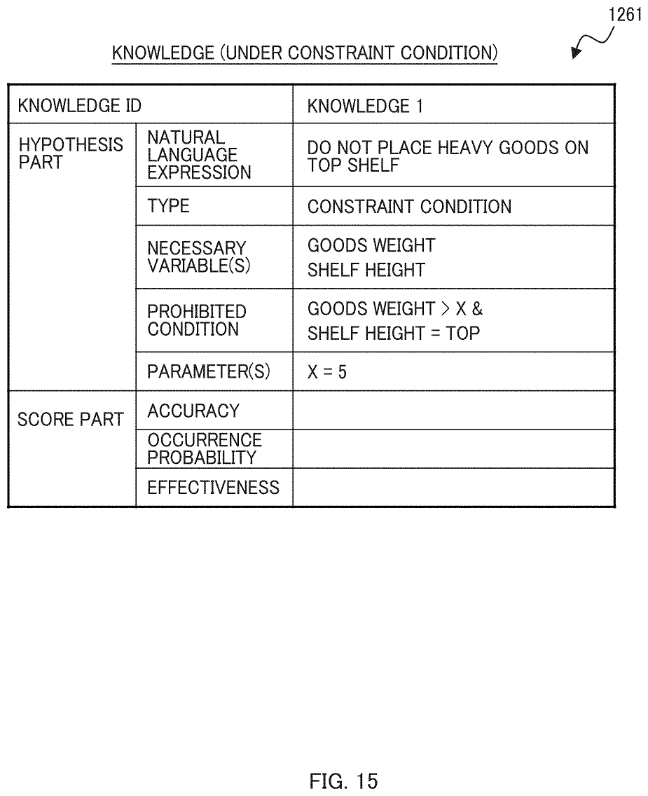

In this case, the knowledge selection unit 110 performs the following process of s30 on the piece(s) of knowledge (see FIG. 15) whose “type” is the constraint condition in the selection knowledge list 1103. Specifically, if “necessary variable(s)” for the piece(s) of knowledge whose type is the constraint condition among the pieces of knowledge in the selection knowledge list 1103 are not stored in the necessary variable list 1102 (see FIG. 13), the knowledge selection unit 110 adds the necessary variable(s) to the necessary variable list 1102 (s30).

The knowledge selection unit 110 performs such a process for all the pieces of knowledge in the selection knowledge list 1103 to generate the necessary variable list 1102, and passes the necessary variable list 1102 to the pre-processing unit 111 and the measure implementation unit 116 (s31), and then the process ends.

<Data Analysis Method: Flow Example in Pre-Processing Unit>

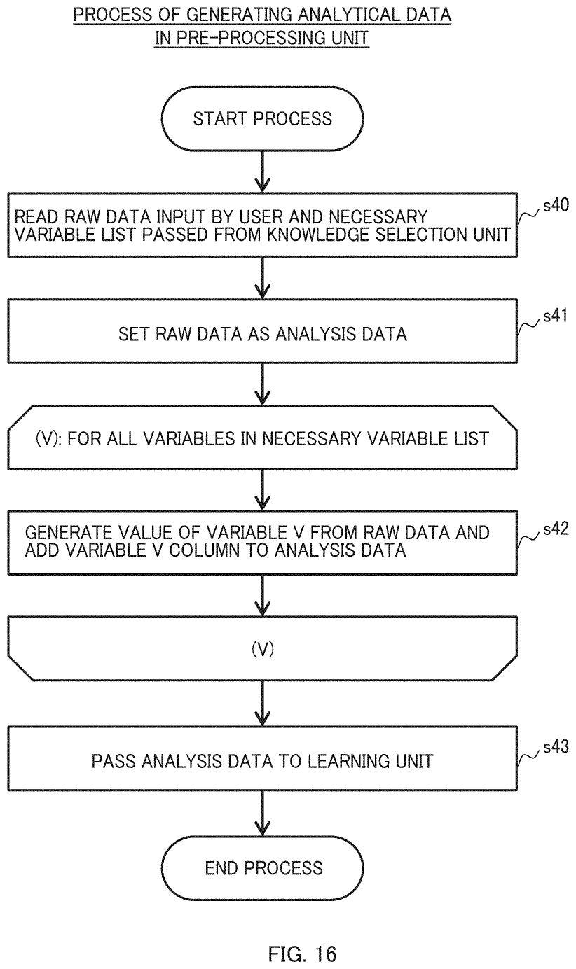

Next, a process of generating the analysis data 1112 in the pre-processing unit 111 will be described. FIG. 16 illustrates a flow example in the data analysis method according to the present embodiment, specifically, the process of generating the analysis data in the pre-processing unit 111.

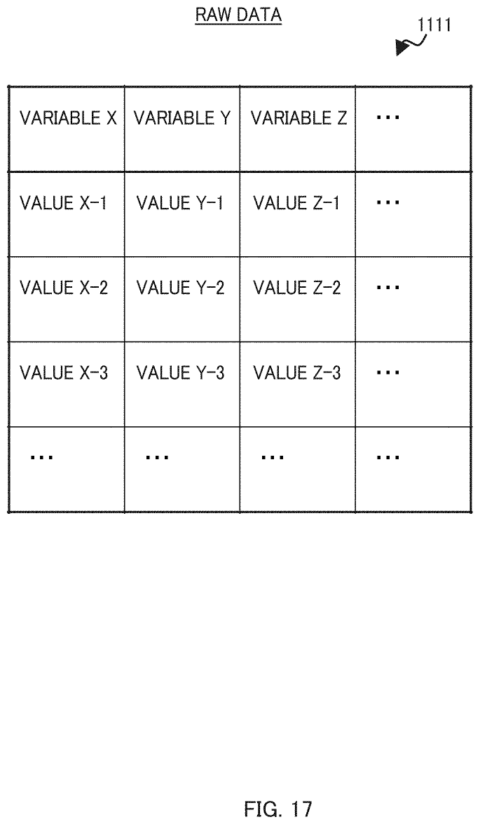

In this case, the pre-processing unit 111 acquires the raw data 1111 (see FIG. 17) input by the user via the user terminal 200, and the necessary variable list 1102 described above (s40). The raw data 1111 is a list of the values of the variables observed for the target case, as illustrated in FIG. 17.

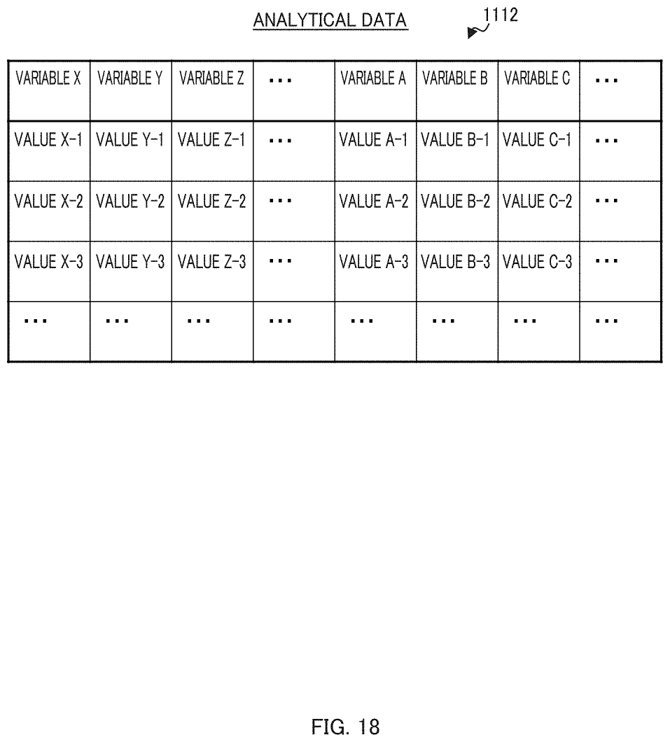

Further, the pre-processing unit 111 sets the above-mentioned raw data 1111 as data to be analyzed next, that is, the analysis data 1112 (s41), specifies variables not included in the raw data 1111 among the necessary variables defined in the necessary variable list 1102, calculates values of the specified variables from, for example, the values of the existing variables of the raw data 1111, and adds the calculated values to the analysis data 1112 (see FIG. 18) (s42).

For example, if variable A, which is not included in the raw data 1111 among the necessary variables defined in the necessary variable list 1102, can be calculated by substituting each value of variable G and variable T into a predetermined mathematical expression K, the pre-processing unit 111 calculates the value of variable A by substituting the values of variable G and variable T indicated in the respective records of the raw data 1111 into the mathematical expression K, and specifies an average value or a median value between the records.

The pre-processing unit 111 performs the above-described process of s42 on all variables in the necessary variable list 1102 to generate the analysis data 1112, passes the analysis data 1112 to the learning unit 112 (s43), and then the process ends.

<Data Analysis Method: Flow Example in Learning Unit>

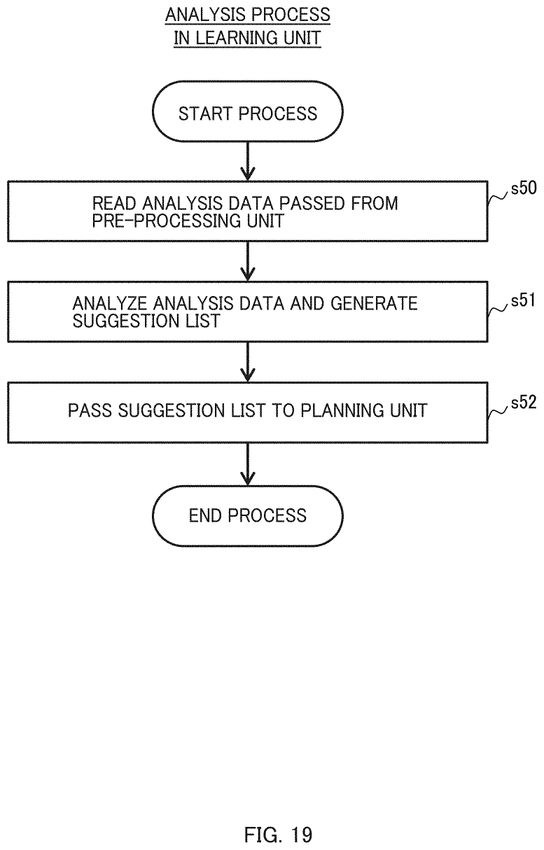

Next, an analysis process in the learning unit 112 will be described. FIG. 19 illustrates an example of a flow of the data analysis method according to the present embodiment, specifically, the analysis process performed in the learning unit 112.

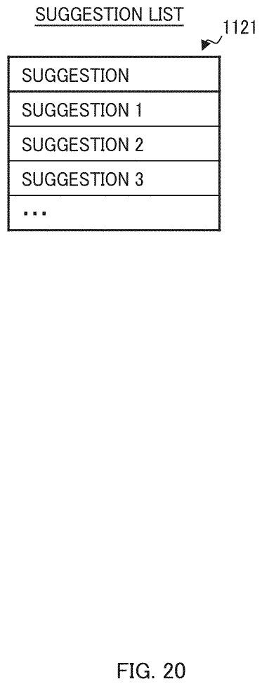

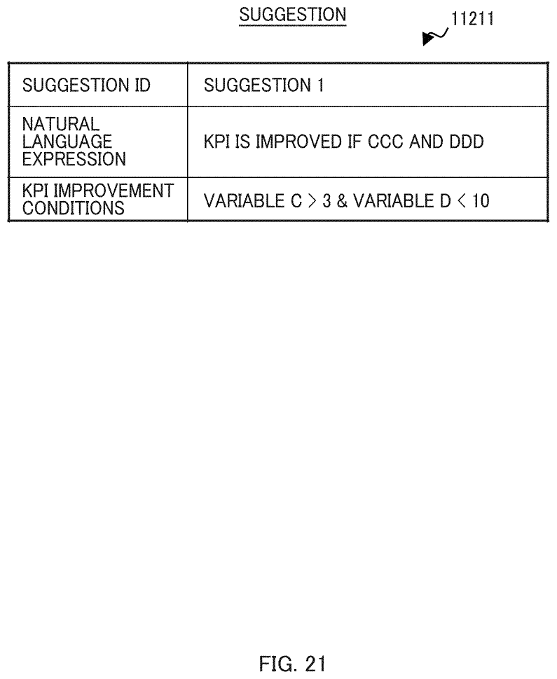

In this case, the learning unit 112 acquires the analysis data 1112 from the pre-processing unit 111 described above (s50). Further, the learning unit 112 inputs the value of each variable indicated by the analysis data 1112 and the evaluation index such as picking process time to the analysis engine 1021, and performs a correlation analysis for a relation between the variable and the evaluation index to specify information related to a combination of variables that improves the evaluation index, as a suggestion for improvement of the evaluation index (s51). FIG. 20 illustrates the improvement suggestion list 1121 obtained in s51, and FIG. 21 illustrates an example of suggestion 11211 included in the list 1121.

<Data Analysis Method: Flow Example 1 in Planning Unit>

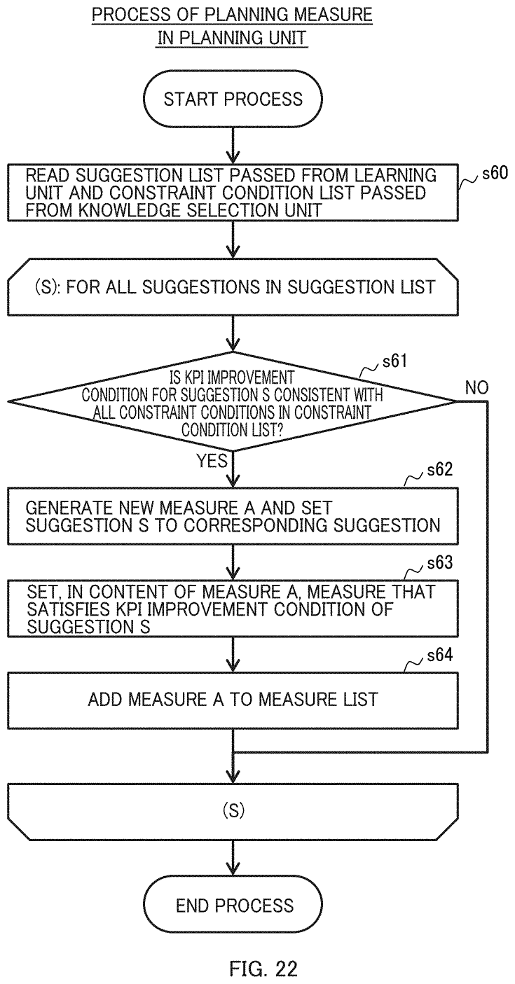

Next, a process of planning a measure in the planning unit 113 will be described. FIG. 22 illustrates an example of a flow of the data analysis method according to the present embodiment, specifically, the process of planning a measure in the planning unit 113.

In this case, the planning unit 113 acquires the improvement suggestion list 1121 from the learning unit 112, and acquires the constraint condition list 1104 from the knowledge selection unit 110 (s60).

Further, the planning unit 113 performs the processes of s61 to s64 for each suggestion included in the improvement suggestion list 1121 obtained in s60. Specifically, the planning unit 113 determines whether the “KPI improvement condition” of a certain suggestion is consistent with all the constraint conditions in the constraint condition list 1104 (s61).

As a result of this determination, if the “KPI improvement condition” of the suggestion is inconsistent with any of the constraint conditions in the constraint condition list 1104 (s61: No), the process for that suggestion ends in the planning unit 113, and then the processing proceeds to the process for the next suggestion.

On the other hand, as a result of the above determination, if the “KPI improvement condition” of the suggestion is consistent with all the constraint conditions of the constraint condition list 1104 (s61: Yes), the planning unit 113 generates a new measure, such as “Make C greater than 3 and make D less than 10”, based on the KPI improvement condition, such as “variable C>3 & variable D<10”, indicated by the suggestion, and associates the measure with the suggestion (s62, S63).

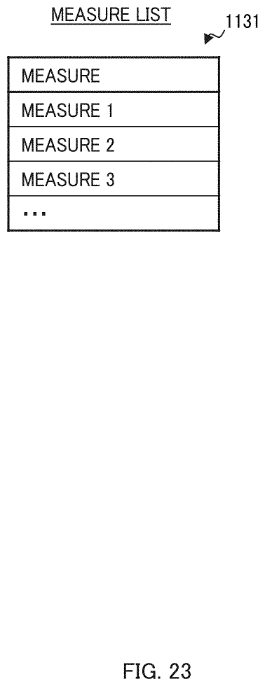

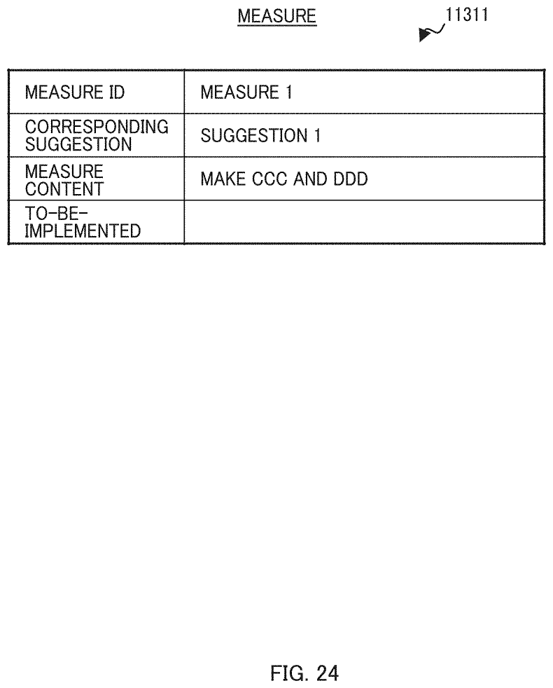

Further, the planning unit 113 adds the above-mentioned new measure 11311 (see FIG. 24) obtained in s62 and s63 to the measure list 1131 (see FIG. 23). When the planning unit 113 has performed the above-described processes of s61 to s64 on all the suggestions included in the suggestion list 1121, then the processing ends.

<Data Analysis Method: Flow Example 2 in Planning Unit>

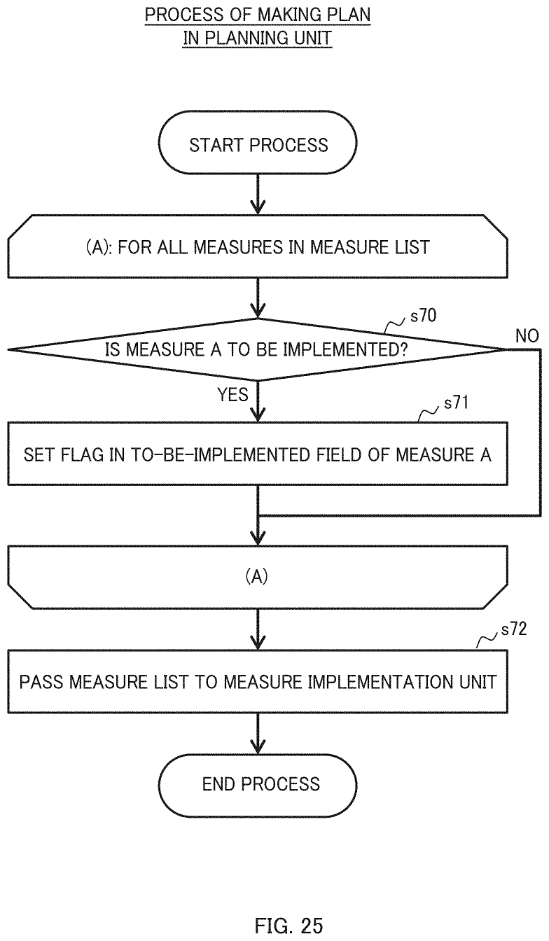

Next, a process of making a plan in the planning unit 113 will be described. FIG. 25 illustrates an example of a flow of the data analysis method according to the present embodiment, specifically, the process of making a plan in the planning unit 113.

In this case, the planning unit 113 performs the processes of s70 to 71 on all the measures in the measure list 1131 obtained in the above-mentioned flow. Specifically, the planning unit 113 determines whether a certain measure included in the measure list 1131 is to be implemented, based on either whether or not an instruction is received from the user terminal 200 or whether or not a predetermined implementation criterion (e.g., an acceptable range of conditions defined by the measure) is satisfied (s70).

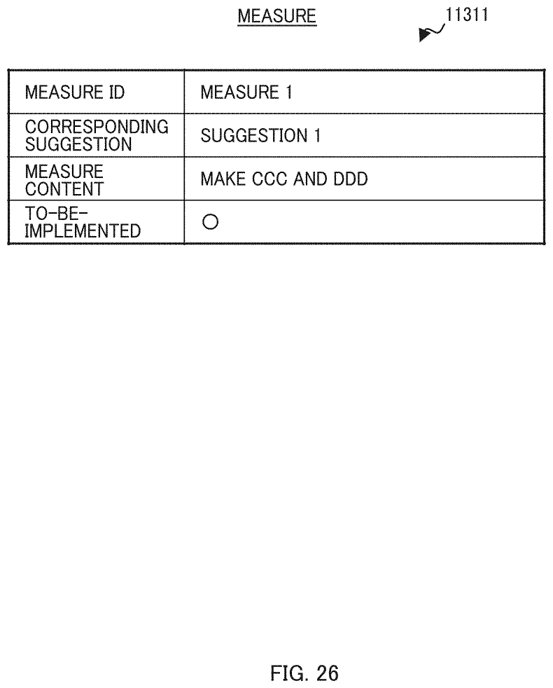

As a result of the above determination, if the measure is not to be implemented (s70: No), the process for that measure in the planning unit 113 ends, and then the processing proceeds to the process for the next measure. On the other hand, as a result of the above determination, if the measure is to be implemented (s70: Yes), the planning unit 113 sets a predetermined flag in a to-be-implemented field (see FIG. 26) for the measure in the measure list 1131 (see s71), and then the processing proceeds to the process for the next measure.

The planning unit 113, when having performed the processes of s70 and s71 described above for each measure in the measure list 1131, passes the resulting completed measure list 1131 to the measure implementation unit 116 (s72), and then the process ends.

<Data Analysis Method: Flow Example in Measure Implementation Unit>

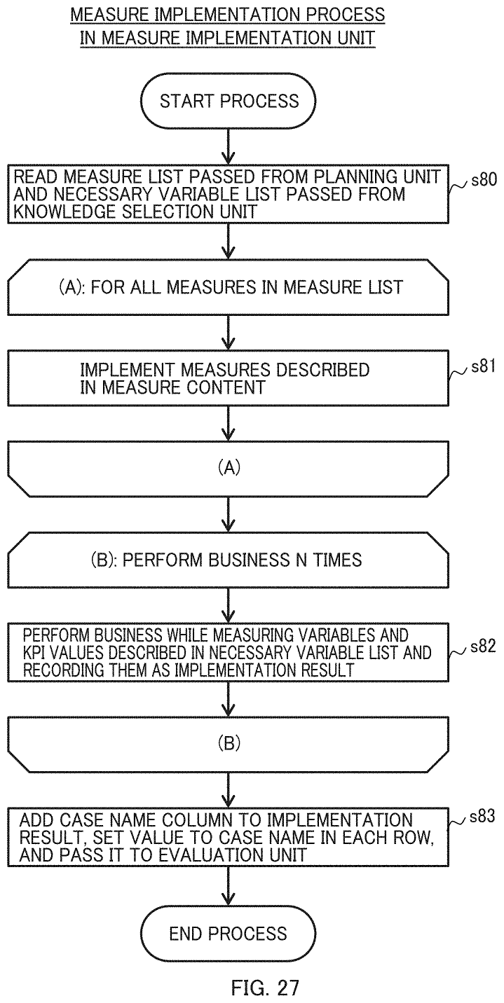

Next, a measure implementation process in the measure implementation unit 116 will be described. FIG. 27 illustrates an example of a flow of the data analysis method according to the present embodiment, specifically, the measure implementation process in the measure implementation unit 116.

In this case, the measure implementation unit 116 acquires the measure list 1131 from the planning unit 113, and acquires the necessary variable list 1102 from the knowledge selection unit 110 (s80). Further, the measure implementation unit 116 implements each measure included in the measure list 1131 obtained here (s81). There are expected two cases: a case where the measure is implemented by the measure implementation unit 116, and a case where the measure is implemented by a person in charge and then the measure implementation unit 116 obtains its result.

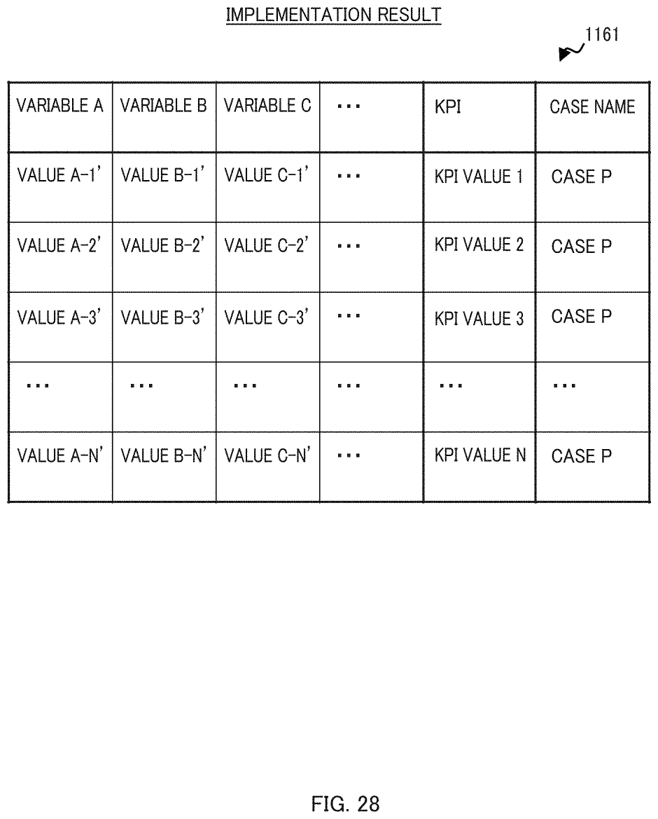

Further, the measure implementation unit 116 measures values of variables and KPI values (e.g., picking process time) to be written in the necessary variable list 1102 described above or acquires them from the user terminal 200 or the external system 300 while a business process to which the above measure is applied is performed a predetermined number of times, and stores the values as the measure implementation result 1161 (see FIG. 28) (s82).

The measure implementation unit 116 sets a case name in the implementation result 1161 by performing each of the above processes, and passes the case name to the evaluation unit 114 (s83), and then the process ends.

<Data Analysis Method: Flow Example 1 in Evaluation Unit>

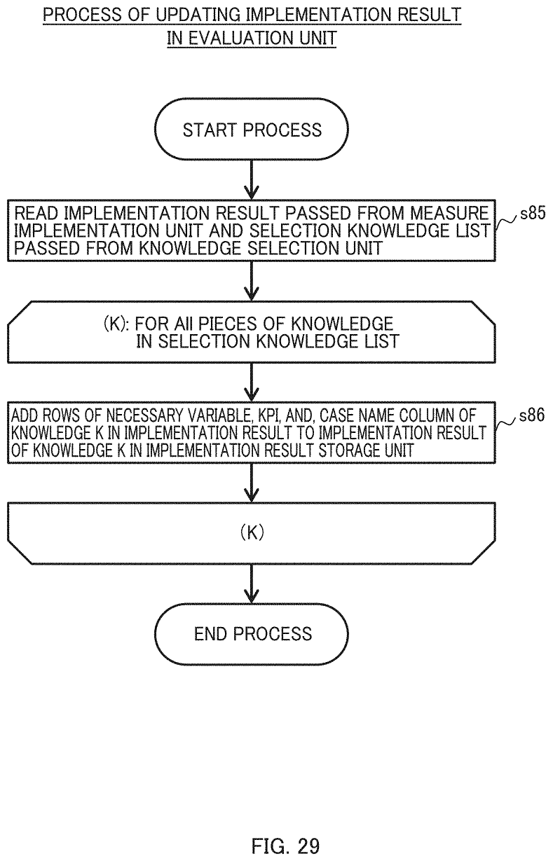

Next, a process of updating the implementation result in the evaluation unit 114 will be described. FIG. 29 illustrates an example of a flow of the data analysis method according to the present embodiment, specifically, a process of updating the implementation result in the evaluation unit 114.

In this case, the evaluation unit 114 acquires the implementation result 1161 from the above-mentioned measure implementation unit 116, acquires the selection knowledge list 1103 from the knowledge selection unit 110 (s85), and performs the following s86 on each piece of knowledge included in the selection knowledge list 1103.

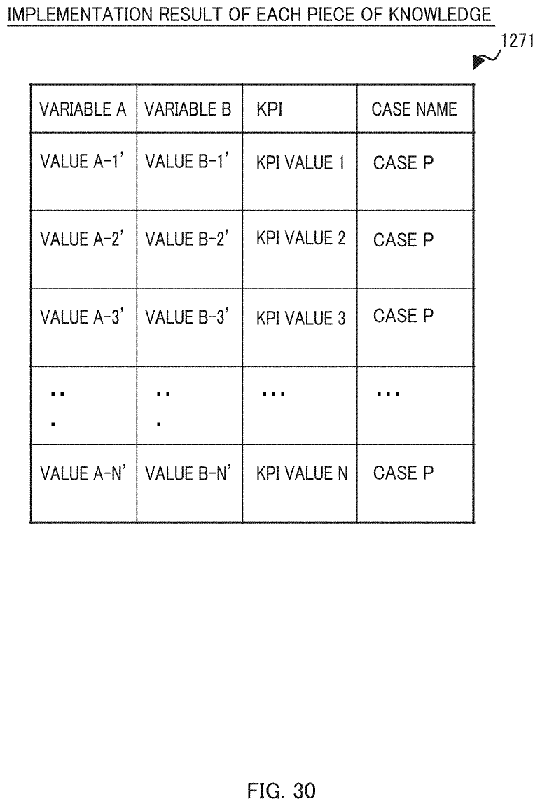

Specifically, for each piece of knowledge in the selection knowledge list 1103, the evaluation unit 114 adds the values of necessary variable, KPI, and case name, associated with the piece of knowledge in the above-mentioned implementation result 1161, to an implementation result 1271 of that piece of knowledge in the implementation result storage unit 127 (see FIG. 30) (s86).

When the evaluation unit 114 has performed the above-mentioned s86 on all the pieces of knowledge in the selection knowledge list 1103, then the process ends.

<Data Analysis Method: Flow Example 2 in Evaluation Unit>

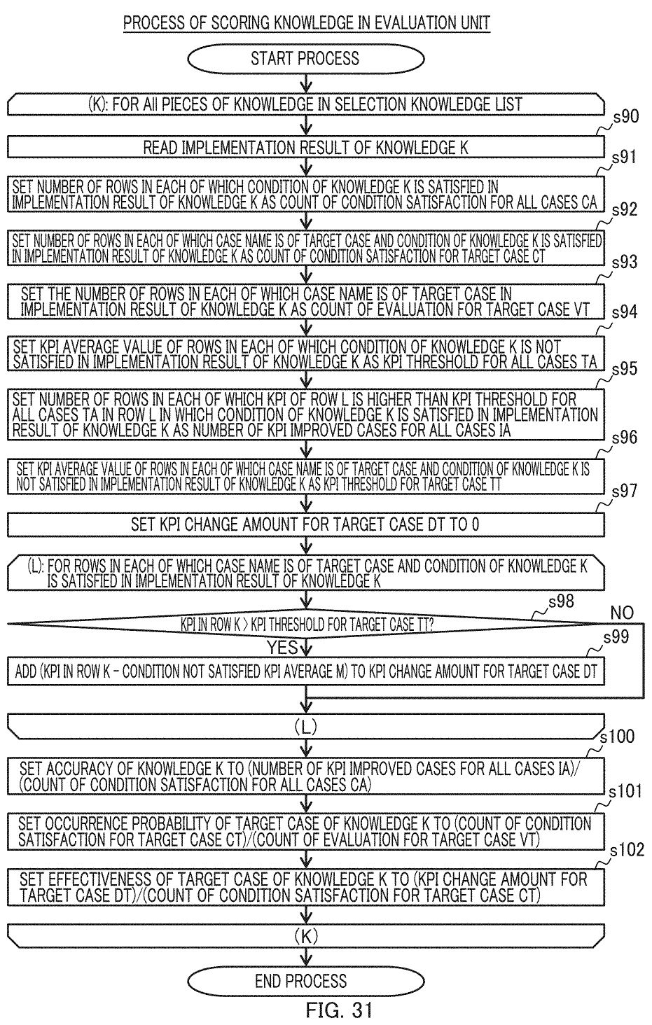

Next, a scoring process in the evaluation unit 114 will be described. FIG. 31 illustrates an example of a flow of the data analysis method according to the present embodiment, specifically, the scoring process in the evaluation unit 114.

In this case, the evaluation unit 114 performs the following s90 to s102 on each piece of knowledge in the selection knowledge list 1103. Specifically, the evaluation unit 114 acquires an implementation result from the implementation result 1271 for each piece of knowledge which is a predetermined piece of knowledge in the selection knowledge list 1103 (s90).

Further, the evaluation unit 114 sets, in the memory 103, the number of records in each of which the corresponding condition of the piece of knowledge is satisfied in the implementation result acquired in s90, as a count of condition satisfaction for all cases CA (s91).

Then, the evaluation unit 114 sets, in the memory 103, the number of records in each of which the corresponding case name is of the target case and the corresponding condition of the piece of knowledge is satisfied in the implementation result 1271 of each piece of knowledge, as a count of condition satisfaction for target case CT (s92).

Further, the evaluation unit 114 sets, in the memory 103, the number of records in each of which the corresponding case name is of the target case in the implementation result acquired in s90, as a count of evaluation for target case VT (s93).

Then, the evaluation unit 114 sets, in the memory 103, a KPI average value of the rows in each of which the corresponding condition of the piece of knowledge is not satisfied in the implementation result acquired in s90, as a KPI threshold for all cases TA (s94).

Further, the evaluation unit 114 sets, in the memory 103, the number of records in each of which the KPI of a row L is higher than the KPI threshold for all cases TA in the row L in which the corresponding condition of the piece of knowledge is satisfied in the implementation result acquired in s90, as the number of KPI improved cases for all cases IA (s95).

Then, the evaluation unit 114 sets, in the memory 103, a KPI average value of the rows in each of which the corresponding case name is of the target case and the corresponding condition of the piece of knowledge is not satisfied in the implementation result acquired in s90, as a KPI threshold for target case TT (s96).

Further, the evaluation unit 114 sets a KPI change amount for target case DT to 0 (s97). Then, the evaluation unit 114 performs the following s98 to s99 for the record in which the case name is of the target case and the condition of the piece of knowledge is satisfied in the implementation result acquired in s90. Specifically, the evaluation unit 114 determines whether or not the KPI in the record is higher than the KPI threshold for target case TT (s98).

As a result of the above determination, if the KPI in the record is not higher than the KPI threshold for target case TT (s98: No), the processing proceeds to the process for the next row in the evaluation unit 114. On the other hand, if the KPI in the record is higher than the KPI threshold for target case TT (s98: Yes), the evaluation unit 114 adds the value of (the KPI in the record—a condition not satisfied KPI average M) to the KPI change amount for target case DT (s99).

Then, the evaluation unit 114 sets the accuracy of the corresponding piece of knowledge to (the number of KPI improved cases for all cases IA)/(the count of condition satisfaction for all cases CA) (s100).

Further, the evaluation unit 114 sets the occurrence probability of the target case of the piece of knowledge to (the count of condition satisfaction for target case CT)/(the count of evaluation for target case VT) (s101).

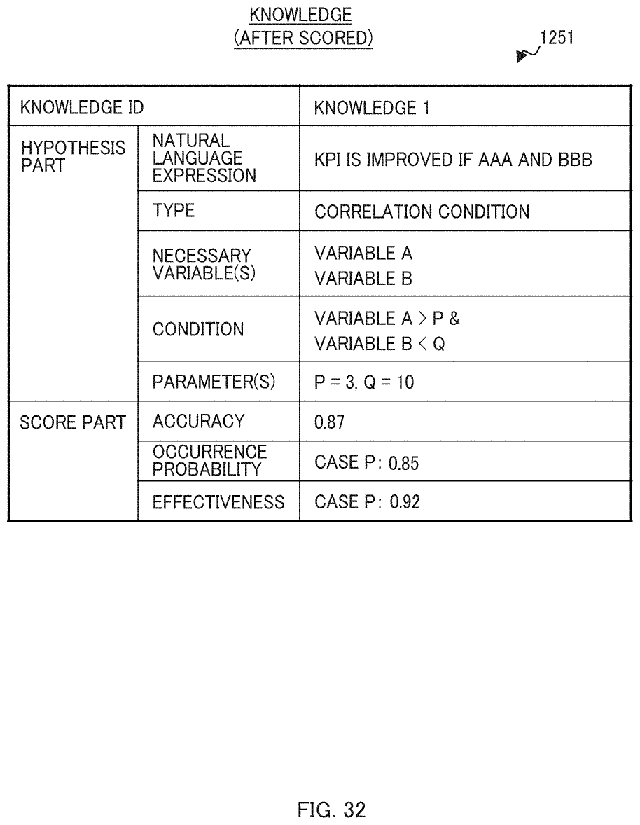

Then, the evaluation unit 114 sets the effectiveness of the target case of the piece of knowledge to (the KPI change amount for target case DT)/(the count of condition satisfaction for target case CT) (s102), and the process ends. An example of the piece of knowledge that has undergone the processes up to this point is illustrated as knowledge 1251 in FIG. 32.

<Data Analysis Method: Flow Example 3 in Evaluation Unit>

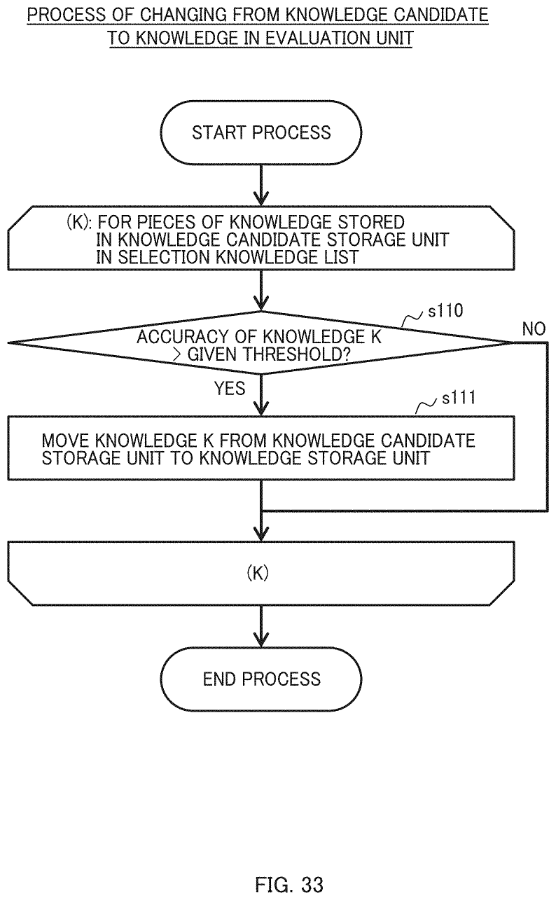

Next, a process of changing the registration destination of knowledge in the evaluation unit 114 will be described. FIG. 33 illustrates an example of a flow of the data analysis method according to the present embodiment, specifically, the process of changing the registration destination of knowledge in the evaluation unit 114.

In this case, the evaluation unit 114 performs the following s110 and sill on the piece of knowledge stored in the knowledge candidate storage unit 126, among the pieces of knowledge in the selection knowledge list 1103. Specifically, the evaluation unit 114 determines whether or not the accuracy of the piece of knowledge is higher than a predetermined threshold (s110).

As a result of the above determination, if the accuracy of the piece of knowledge is not higher than the predetermined threshold (s110: No), the evaluation unit 114 moves the piece of knowledge from the knowledge candidate storage unit 126 to the knowledge storage unit 125 (sill), and then the processing proceeds to the process for the next piece of knowledge.

On the other hand, as a result of the above determination, if the accuracy of the piece of knowledge is higher than the predetermined threshold (s110: Yes), the processing directly proceeds to the process for the next piece of knowledge in the evaluation unit 114.

When the evaluation unit 114 has performed the above-mentioned s110 and sill on all the pieces of knowledge in the selection knowledge list 1103, then the process ends.

<Knowledge Score Prediction Unit>

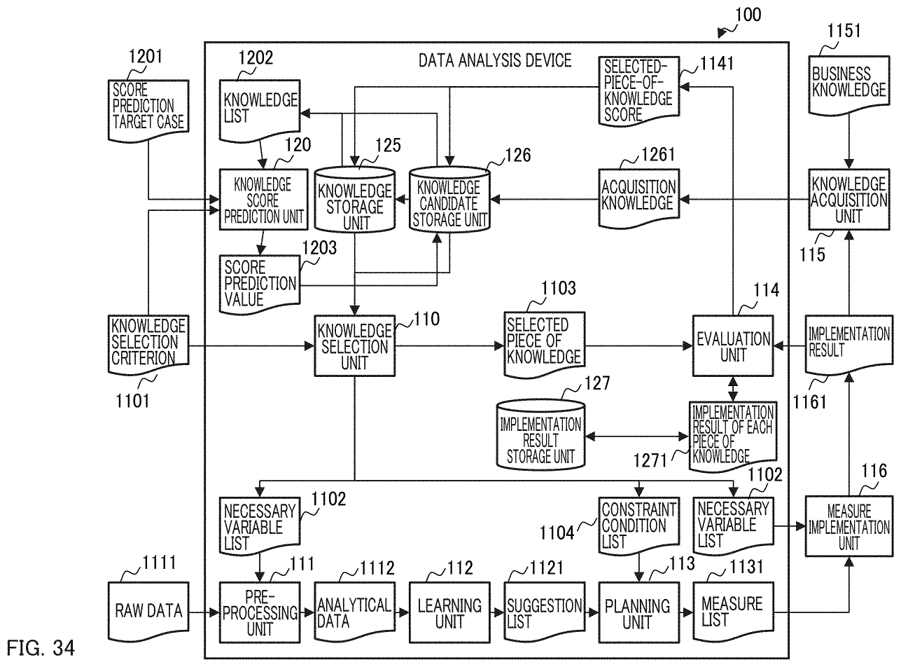

Note that it is preferable that the data analysis device 100 according to the present embodiment further includes a knowledge score prediction unit 120. An example of a functional configuration in this case is as illustrated in FIG. 34. As illustrated in FIG. 34, the knowledge score prediction unit 120 receives inputs of a score prediction target case 1201, the knowledge selection criterion 1101, and a knowledge list 1202 to calculate a score prediction value 1203, and adds the calculated score prediction value 1203 to the corresponding piece of knowledge in the knowledge candidate storage unit 126.

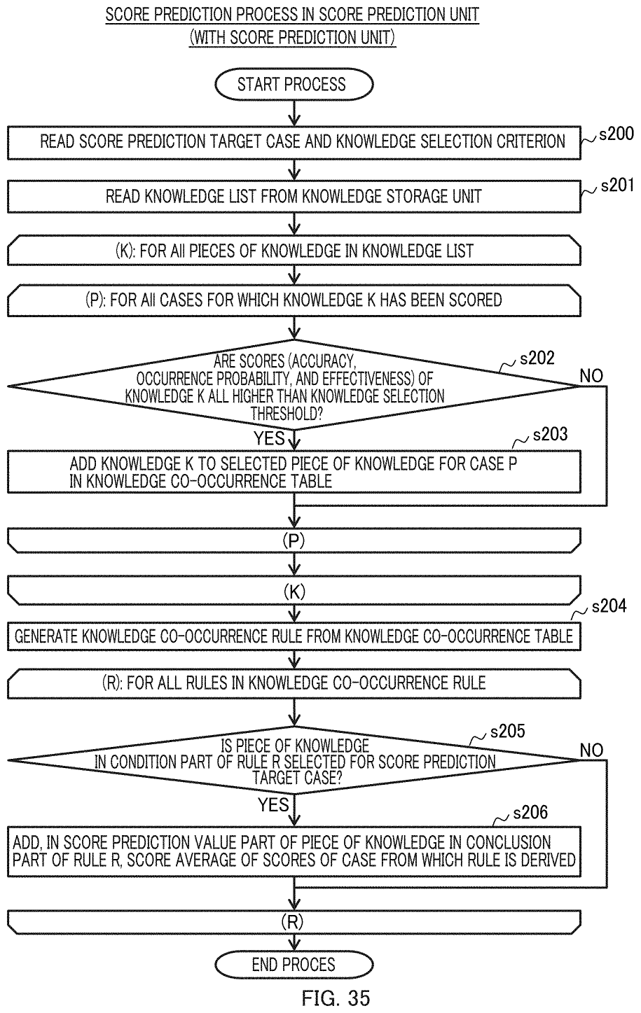

A process flow in the knowledge score prediction unit 120 will be described below. FIG. 35 illustrates an example of a flow of the data analysis method of the present embodiment, specifically, a score prediction process in the score prediction unit 120.

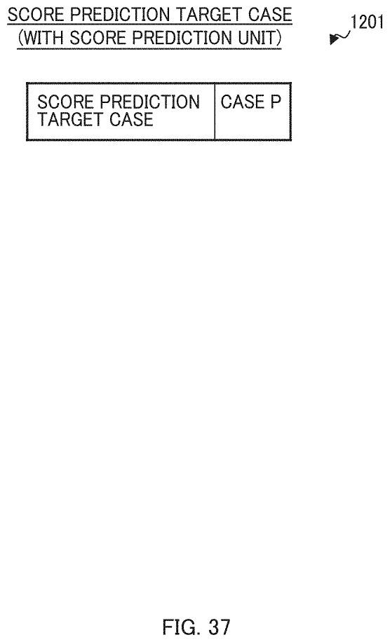

In this case, the score prediction unit 120 acquires the score prediction target case 1201 (see FIG. 37) and the knowledge selection criterion 1101 (s200). The score prediction target case 1201 may be received by a user's specification via the user terminal 200, for example.

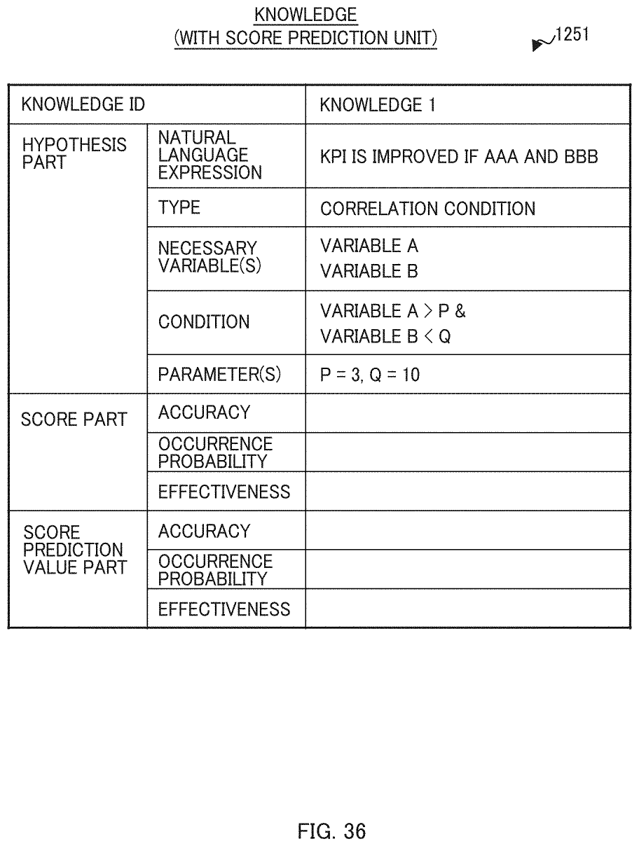

Further, the score prediction unit 120 acquires a knowledge list from the knowledge storage unit 125 (s201), and performs the following processes of s202 and s203 for each piece of knowledge (see FIG. 36) in this knowledge list. Specifically, the score prediction unit 120 determines whether or not the scores (accuracy/occurrence probability/effectiveness) of the piece of knowledge are all equal to or higher than the thresholds defined by the knowledge selection criterion 1101 for all the cases in which a predetermined piece of knowledge has been scored (S202).

As a result of the above determination, if any of the above scores (accuracy/occurrence probability/effectiveness) is not equal to or higher than the corresponding threshold defined by the knowledge selection criterion 1101 (s202: No), the processing proceeds to the process for the next piece of knowledge in the score prediction unit 120.

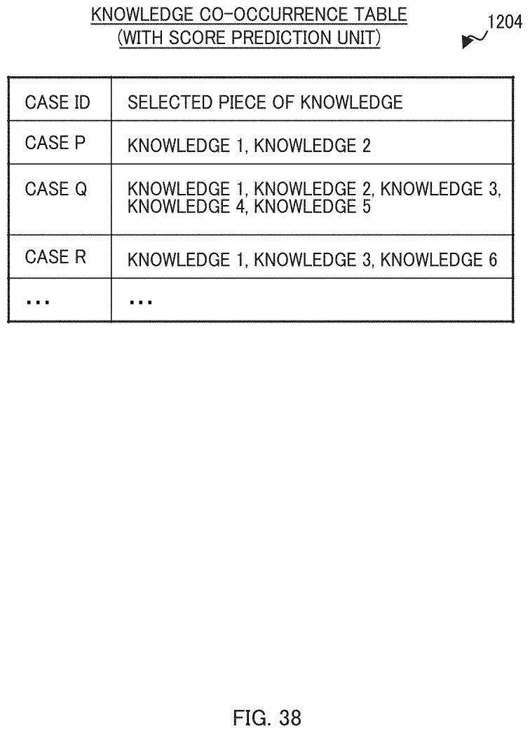

On the other hand, as a result of the above determination, if the above scores (accuracy/occurrence probability/effectiveness) are all equal to or higher than the thresholds defined by the knowledge selection criterion 1101 (s202: Yes), the score prediction unit 120 adds that piece of knowledge in the “selection knowledge” field in the record of case P (the case specified by the score prediction target case 1201) in a knowledge co-occurrence table 1204 (see FIG. 38) (s203).

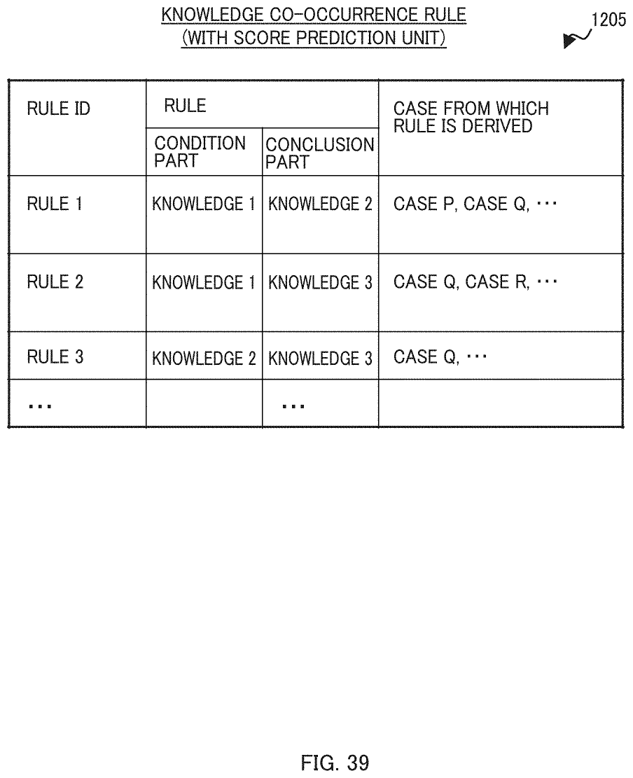

Then, the score prediction unit 120 generates a knowledge co-occurrence rule 1205 (see FIG. 39) from the knowledge co-occurrence table 1204 (s204). According to the generated knowledge co-occurrence rule, for the case of the example in FIG. 38 in which knowledge 1 and knowledge 2 have been obtained for case P, knowledge 1, knowledge 2, knowledge 3, knowledge 4, and knowledge 5 have been obtained for case Q, and knowledge 1, knowledge 2, knowledge 3, and knowledge 6 have been obtained for case R, co-occurrence analysis being performed on these cases makes it possible to determine that knowledge 1 (condition part) and knowledge 2 (conclusion part) have co-occurrence, and knowledge 1 (condition part) and knowledge 3 (conclusion part) have co-occurrence. As the co-occurrence analysis method itself, an existing method may be adopted as appropriate.

Note that although only knowledge 1 and knowledge 2 have been obtained for the target case P, knowledge 3 may also be specified as effective for case P in consideration of the results of the co-occurrence analysis described above.

Further, the score prediction unit 120 performs the following processes of s205 and s206 on all the rules in the knowledge co-occurrence rule. Specifically, the score prediction unit 120 determines whether or not a piece of knowledge in the condition part of a predetermined rule is selected for the score prediction target case (s205). This selection means a selection made by the user via the user terminal 200.

As a result of the above determination, if the piece of knowledge in the condition part of the predetermined rule is not selected for the score prediction target case (s205: No), the processing proceeds to the process for the next rule in the score prediction unit 120.

On the other hand, as a result of the above determination, if the piece of knowledge in the condition part of the predetermined rule is selected for the score prediction target case (s205: Yes), the score prediction unit 120 adds, in a score prediction value part (see FIG. 36) of the piece of knowledge in the conclusion part of the corresponding rule, an average or a median of the scores of the case from which the rule is derived (e.g., case Q or case R) (s206), and then the process ends.

<Data Analysis Method: Flow Example in Knowledge Selection Unit>

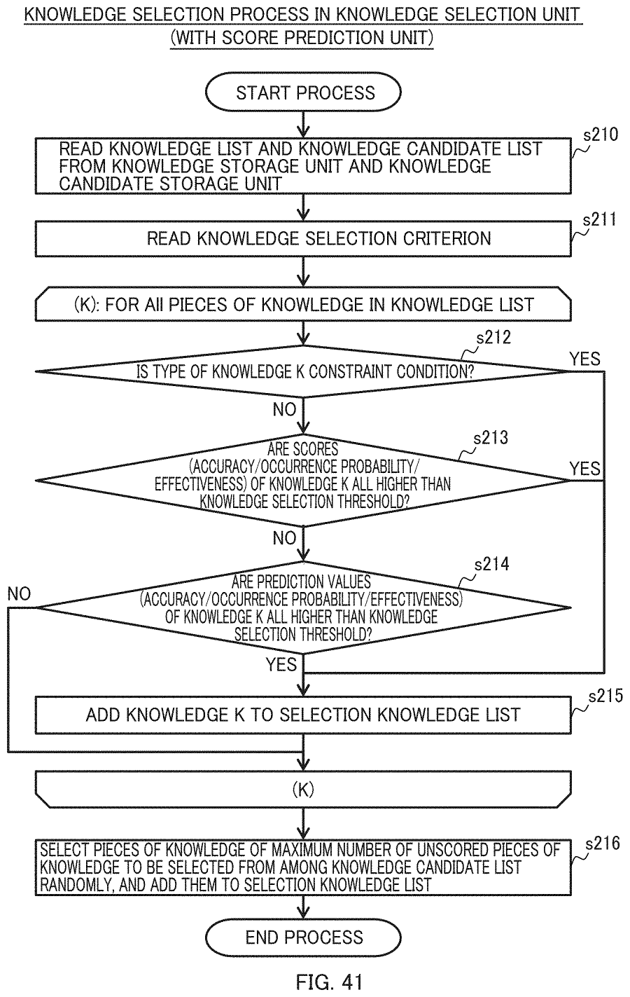

A flow in the knowledge selection unit 110 in the case where the data analysis device 100 includes the score prediction unit 120 as described above will be described. FIG. 41 illustrates a flow example in the data analysis method according to the present embodiment, specifically, a knowledge selection process in the knowledge selection unit 110.

In this case, the knowledge selection unit 110 acquires a knowledge list and a knowledge candidate list from the knowledge storage unit 125 and the knowledge candidate storage unit 126 (s210).

Further, the knowledge selection unit 110 reads the knowledge selection criterion 1101 (see FIG. 10) (s211), and performs the processes of s212 to s215 for each piece of knowledge in the knowledge list obtained in s210.

In s212 of these processes, the knowledge selection unit 110 determines whether the value in the “type” field is the “constraint condition” for the piece of knowledge to be processed. As a result of this determination, if the piece of knowledge corresponds to the “constraint condition” (s212: Yes), the knowledge selection unit 110 adds the piece of knowledge to a selection knowledge list 1103 (s215).

On the other hand, as a result of the above determination, if the piece of knowledge does not correspond to the “constraint condition” (s212: No), the knowledge selection unit 110 determines whether the values of the items of accuracy, occurrence probability, and effectiveness in the score part for the piece of knowledge are all higher than the values defined by the knowledge selection criterion 1101 (s213).

As a result of this determination, if the values of the items of accuracy, occurrence probability, and effectiveness for the piece of knowledge are all higher than the values defined by the knowledge selection criterion 1101 (s213: Yes), the knowledge selection unit 110 determines whether or not the predicted values of the items of accuracy, occurrence probability, and effectiveness for the piece of knowledge are all higher than the values defined by the knowledge selection criterion 1101 (s214).

As a result of this determination, if any of the predicted values of the items of accuracy, occurrence probability, and effectiveness for the piece of knowledge is not higher than the corresponding value defined by the knowledge selection criterion 1101 (s214: No), the knowledge selection unit 110 does not add the piece of knowledge to the selection knowledge list 1103, and the processing proceeds to the process for another piece of knowledge.

On the other hand, as a result of the above determination, if the predicted values of the items of accuracy, occurrence probability, and effectiveness for the piece of knowledge are all higher than the values defined by the knowledge selection criterion 1101 (s214: Yes), the knowledge selection unit 110 adds the piece of knowledge to the selection knowledge list 1103 (s215).

When the processes of s212 to s215 described above have been performed on all pieces of knowledge in the knowledge list, the knowledge selection unit 110 randomly selects, from among the knowledge candidate list, pieces of knowledge of the “maximum number of unscored pieces of knowledge to be selected” in the knowledge selection criterion 1101, adds the selected pieces of knowledge to the selection knowledge list 1103 (s216), and then the process ends.

<Output Example>

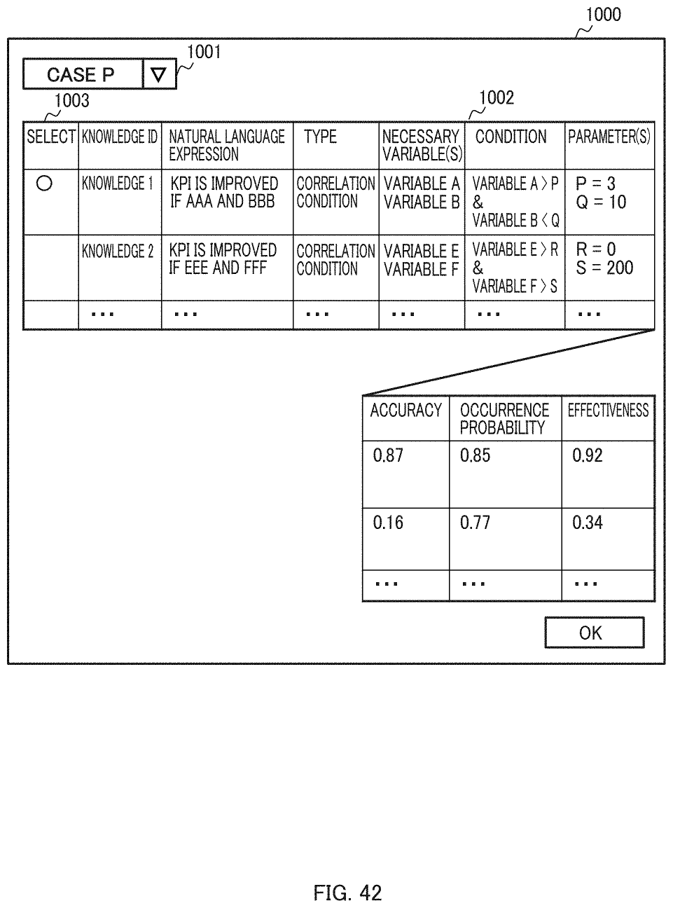

Note that the data analysis device 100 according to the present embodiment may perform each of the flows described above, calculate scores associated with each piece of knowledge, for example, for “case P”, and display the resulting scores on a screen 1000 of the user terminal 200 (see FIG. 42).

The screen 1000 illustrated in FIG. 42 has a screen configuration including a display field 1001 for the target case and a table 1002. Of these elements, the table 1002 is a table made up of records including fields of selection, knowledge ID, natural language expression, type, necessary variable(s), conditions, parameter(s), accuracy, occurrence probability, and effectiveness.

Of these fields, a selection field 1003 is an interface that allows the user who is browsing the table 1000 on the user terminal 200 to select the field by, for example, clicking, when the user determines that the corresponding piece of knowledge is to be adopted for the corresponding case (in this case, “case P”). The result selected here can correspond to the presence or absence of a selected piece of knowledge in s205 in the flow of FIG. 35, for example.

Although the above description is specific for the best mode for carrying out the present invention, the present invention is not limited to this, and various modifications are possible without departing from the spirit and scope of the invention.

According to the embodiments as described above, it is possible to determine useful business knowledge depending on cases to provide an effective suggestion for business improvement with high accuracy.

At least the following will be made clear by the description in the present specification. In the data analysis device according to the present embodiment, the computing device may be configured to further perform a process of acquiring an implementation result of a measure based on the suggestion for improvement from a predetermined device, and scoring a piece of knowledge corresponding to the suggestion for improvement based on at least a record value of the evaluation index indicated by the implementation result, and select a piece of knowledge on which the process of extracting the variables is to be performed from the storage device according to a score obtained by the scoring.

According to this configuration, it is possible to efficiently pre-select, as a processing target population, the piece of knowledge that can be determined to be suitable for the degree of contributing to business improvement and the like, and, in turn, to determine useful business knowledge depending on cases, thereby providing an effective suggestion for business improvement with higher accuracy.

Further, in the data analysis device according to the present embodiment, the storage device may be configured to further store information on pieces of knowledge obtained for respective predetermined cases, and the computing device may be configured to further perform a process of extracting, for a piece of knowledge that has not been scored among pieces of knowledge for a case to be processed and is of another case different from the case to be processed, a score obtained for the piece of knowledge from the information on pieces of knowledge stored in the storage device, and performing score analogy based on the extracted score.

According to this configuration, it is possible to efficiently estimate the score of a piece of knowledge whose score has not been calculated, from the pieces of knowledge whose score has already been calculated. In addition, it is possible to determine useful business knowledge depending on cases to provide an effective suggestion for business improvement with higher accuracy.

Further, in the data analysis device according to the present embodiment, the computing device may be configured to perform a co-occurrence analysis on the piece of knowledge based on the information of pieces of knowledge obtained for the respective cases, specify a piece of knowledge that can co-occur for the case to be processed, and perform the score analogy on a piece of knowledge that has not been scored.

According to this configuration, it is possible to perform the above-mentioned score analogy more efficiently based on the co-occurrence of pieces of knowledge between cases. In addition, it is possible to determine useful business knowledge depending on cases to provide an effective suggestion for business improvement with higher accuracy.

Further, in the data analysis device according to the present embodiment, the computing device may be configured to store, as a candidate for knowledge, information related to a combination that improves the evaluation index in the storage device, and further perform a process of storing, as a piece of knowledge, the candidate for knowledge when the score obtained by the scoring for the candidate for knowledge is higher than a predetermined reference, in the storage device.

According to this configuration, it is possible to manage each piece of knowledge according to a change of its usefulness, and maintain and manage the knowledge population to be selected as a variable extraction target in satisfactory quality. In addition, it is possible to determine useful business knowledge depending on cases to provide an effective suggestion for business improvement with higher accuracy.

Further, in the data analysis device according to the present embodiment, the computing device may be configured to further perform a process of outputting, to a predetermined device, information on the piece of knowledge selected according to the score on which the process is to be performed.

According to this configuration, the above-mentioned piece of knowledge that may be a measure for business improvement or the like can be visually presented to the user, thereby promoting understanding and effective utilization of the knowledge. In addition, it is possible to determine useful business knowledge depending on cases to provide an effective suggestion for business improvement with higher accuracy.

Further, the data analysis method according to the present embodiment may further include, by the information processing device, performing a process of acquiring an implementation result of a measure based on the suggestion for improvement from a predetermined device, and scoring a piece of knowledge corresponding to the suggestion for improvement based on at least a record value of the evaluation index indicated by the implementation result, and selecting a piece of knowledge on which the process of extracting the variables is to be performed from the storage device according to a score obtained by the scoring.

Further, the data analysis method according to the present embodiment may further include, by the image processing device, further storing information on pieces of knowledge obtained for respective predetermined cases in the storage device, and performing a process of extracting, for a piece of knowledge that has not been scored among pieces of knowledge for a case to be processed and is of another case different from the case to be processed, a score obtained for the piece of knowledge from the information on pieces of knowledge stored in the storage device, and performing score analogy based on the extracted score.

Further, the data analysis method according to the present embodiment may further include, by the information processing device, performing a co-occurrence analysis on the piece of knowledge based on the information of pieces of knowledge obtained for the respective cases, specifying a piece of knowledge that can co-occur for the case to be processed, and performing the score analogy on a piece of knowledge that has not been scored.

Further, the data analysis method according to the present embodiment may further include, by the information processing device, storing, as a candidate for knowledge, information related to a combination that improves the evaluation index in the storage device; and performing a process of storing, as a piece of knowledge, the candidate for knowledge in the storage device when the score obtained by the scoring for the candidate for knowledge is higher than a predetermined reference.

Further, the data analysis method according to the present embodiment may further include, by the information processing device, performing a process of outputting, to a predetermined device, information on the piece of knowledge selected according to the score on which the process is to be performed.

What is claimed is:

1. A data analysis device comprising:
a storage device configured to store pieces of knowledge used for data analysis; and
a computing device configured to perform a process of extracting variables defining the pieces of knowledge from the pieces of knowledge, a process of specifying values corresponding to the variables for data to be analyzed, and a process of performing, based on the values corresponding to the variables and a predetermined evaluation index, an analysis process for a relation between the variables and the evaluation index and specifying information related to a combination of the variables for improving the evaluation index as a suggestion for improvement of the evaluation index.

2. The data analysis device according to claim 1, wherein
the computing device is configured to further perform a process of acquiring an implementation result of a measure based on the suggestion for improvement from a predetermined device, and scoring a piece of knowledge corresponding to the suggestion for improvement based on at least a record value of the evaluation index indicated by the implementation result, and select a piece of knowledge on which the process of extracting the variables is to be performed from the storage device according to a score obtained by the scoring.

3. The data analysis device according to claim 2, wherein
the storage device is configured to further store information on respective pieces of knowledge obtained for respective predetermined cases, and
the computing device is configured to further perform a process of extracting, for a piece of knowledge that has not been scored among pieces of knowledge for a case to be processed and is of another case different from the case to be processed, a score obtained for the piece of knowledge from the information on the respective pieces of knowledge stored in the storage device, and performing score analogy based on the extracted score.

4. The data analysis device according to claim 3, wherein
the computing device is configured to perform a co-occurrence analysis on the piece of knowledge based on the information of the respective pieces of knowledge obtained for the respective cases, specify a piece of knowledge capable of co-occurring for the case to be processed, and perform the score analogy on a piece of knowledge that has not been scored among the pieces of knowledge.

5. The data analysis device according to claim 2, wherein
the computing device is configured to store, as a candidate for knowledge, information related to a combination that improves the evaluation index in the storage device, and further perform a process of storing, as a piece of knowledge, the candidate for knowledge in the storage device when the score obtained by the scoring for the candidate for knowledge is higher than a predetermined reference.

6. The data analysis device according to claim 2, wherein
the computing device is configured to further perform a process of outputting, to a predetermined device, information on the piece of knowledge selected according to the score on which the process is to be performed.

7. A data analysis method performed by an information processing device, the data analysis method comprising:
storing, in a storage device, pieces of knowledge used for data analysis; and
performing a process of extracting variables defining the pieces of knowledge from the pieces of knowledge, a process of specifying values corresponding to the variables for data to be analyzed, and a process of performing, based on the values corresponding to the variables and a predetermined evaluation index, an analysis process for a relation between the variables and the evaluation index to specify information related to a combination of the variables for improving the evaluation index as a suggestion for improvement of the evaluation index.

8. The data analysis method according to claim 7, further comprising: by the information processing device,
performing a process of acquiring an implementation result of a measure based on the suggestion for improvement from a predetermined device, and scoring a piece of knowledge corresponding to the suggestion for improvement based on at least a record value of the evaluation index indicated by the implementation result; and
selecting a piece of knowledge on which the process of extracting the variables is to be performed from the storage device according to a score obtained by the scoring.

9. The data analysis method according to claim 8, further comprising: by the information processing device,
further storing information on respective pieces of knowledge obtained for respective predetermined cases in the storage device; and
further performing a process of extracting, for a piece of knowledge that has not been scored among pieces of knowledge for a case to be processed and is of another case different from the case to be processed, a score obtained for the piece of knowledge from the information on the respective pieces of knowledge stored in the storage device, and performing score analogy based on the extracted score.

10. The data analysis method according to claim 9, further comprising: by the information processing device,
performing a co-occurrence analysis on the piece of knowledge based on the information of the respective pieces of knowledge obtained for the respective cases, specifying a piece of knowledge capable of co-occurring for the case to be processed, and performing the score analogy on a piece of knowledge that has not been scored among the pieces of knowledge.

11. The data analysis method according to claim 8, further comprising: by the information processing device,
storing, as a candidate for knowledge, information related to a combination that improves the evaluation index in the storage device; and
performing a process of storing, as a piece of knowledge, the candidate for knowledge in the storage device when the score obtained by the scoring for the candidate for knowledge is higher than a predetermined reference.

12. The data analysis method according to claim 8, further comprising: by the information processing device,
performing a process of outputting, to a predetermined device, information on the piece of knowledge selected according to the score on which the process is to be performed.
